(19) United States
(12) Patent Application Publication
(10) Pub. No.: US 2007/0160175 A1
(43) Pub. Date: Jul. 12, 2007

(54) Systems and methods for force-fluorescence microscopy

(76) Inventor: Matthew J. Lang, Charlestown, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/526,141

(22) Filed: Sep. 22, 2006

Related U.S. Application Data
(60) Provisional application No. 60/720,118, filed on Sep. 23, 2005.

(51) Int. Cl. H05H 1/22

(52) U.S. Cl. 376/103

(57) ABSTRACT

The present invention provides a system generally relating to periodically and synchronously switching between photon beams from at least two emitters that are each projecting photons into an optical trap region. In one embodiment, the system comprises a first emitter capable of emitting photons to form an optical trapping region. The photons emitted from the first emitter of the system optically couple the first emitter to the trapping region. The system further comprises a second emitter capable of emitting photons into the trapping region. Preferably, emitted photons from the second emitter optically couple the second emitter to the trapping region. The system also comprises a modulator capable of periodically coupling photons from at least one of the first or second emitter to the trapping region. In one aspect, the invention provides at least two modulators for periodically and synchronously operating to couple photons from the first and second emitter to the trapping region. The invention also provides a method of using a system such as, for example, for force-fluorescence microscopy.

### CROSS REFERENCE TO RELATED APPLICATIONS

This application claims the benefit of U.S. provisional patent application No. 60/720,118 filed on Sep. 23, 2005, which is incorporated herein in its entirety by reference.

### BACKGROUND OF THE INVENTION

Optical traps are instruments that use a focused light beam to hold micron-scale objects with photon forces in a localized region in space. Optical trapping has become an important research technology in biology and physics and, more recently, in commercial applications. Optical trapping is useful for designing, manipulating, sorting and assembling objects at the nano-molecular scale. In addition, optical trapping can be used to evaluate picoNewton-scale force interactions between molecules (force-probe research) and to control nanostructures and nanoswitches.

A conventional optical trap is initiated by focusing a laser beam through an objective lens of high numerical aperture. The focused light produces a 3-dimensional, radial, intensity gradient, which increases as light converges upon the focus (focal point) and then diminishes as the light diverges from the focus. A dielectric object located closely down-beam of the focus will experience a combination of forces caused by transfer of momentum from photons (photon forces), resulting from both scattering and refraction.

Dielectric objects used alone or as “handles” to manipulate other microscopic objects are typically in the range of about 0.2 to 5 microns, which is the same size range as many biological specimens that can be trapped directly, e.g., bacteria, yeast and organelles of larger cells or indirectly by attaching to trappable objects components such as biological motors, DNA and other specimens.

Optical traps can be constructed using optical gradient forces from a single beam of light to manipulate the position of a small dielectric object, for example, immersed in a fluid medium, whose refractive index is smaller than that of the particle. The optical trapping technique has been generalized to enable manipulation of reflecting, absorbing and low dielectric constant particles as well.

Typically, optical traps have been developed using standard microscopy substrates, primarily, conventional glass microscope slides. A microscopic object to be trapped will usually be immersed in an oil or aqueous fluid medium maintained between two glass slides separated by a spacer. In addition to partially stabilizing and limiting the movement of the object or target, the immersion fluid provides an index of refraction that can be selected to be less than the index of refraction for the object itself, with the ratio of these refractive indices being important to generating the optical trapping forces.

Traditionally, glass substrate slides have been used because they are commonly available for adaptation to microscopic sample stages and because they are substantially transparent to wavelengths of visible light (350 to 700 nanometers) commonly used with microscopy.

Fluorescence microscopy is also an important research technology in biology and physics. Fluorescence microscopy techniques are useful for seeing structures and measuring physiological and biochemical events in living cells. Various fluorescent indicators are available to evaluate many physiologically important chemicals such as DNA, calcium, magnesium, sodium, pH and enzymes. In addition, antibodies that are specific to various biological molecules can be chemically bound to fluorescent molecules and used to stain specific structures within cells.

For example, in biology, the molecular events that initiate from an external mechanical stimulus of a cell are responsible for a number of important cellular processes including signaling, development, survival and migration. Generally referred to as mechanotransduction, the interconversion of mechanical force into a biochemical response is directly related to cell morphology changes, gene expression,. protein synthesis and apoptotic cell death. Furthermore, it has been shown to play both a significant role in chronic diseases, such as atherosclerosis and arthritis, and a key part in acute conditions related to tissue inflammation, repair and remodeling. While the association of mechanotransduction processes to these medical conditions is known further improvements in the understanding of its molecular basis would be useful.

By evaluating the effects of force on binding affinities, it is expected that the molecular mechanism of cell mechanical pathways can be utilized to provide improvements.

### SUMMARY OF THE INVENTION

The present invention provides a system for selectively applying a force to an object using light and selectively measuring an optical property of the object. In one embodiment, the system comprises a first emitter capable of emitting photons to form a trapping region such as, for example, an optical trap or optically trapping region; The photons emitted from the first emitter of the system optically couple the first emitter to the trapping region. The system further comprises a second emitter capable of emitting photons into the trapping region. Preferably, emitted photons from the second emitter optically couple the second emitter to the trapping region.

A preferred embodiment of the invention uses a control system that controls the delivery of light from the first emitter or first light source and the second emitter or second light source. The control system can actuate switches which operate the light sources, or alternatively can actuate a modulator such as a light valve or optical switch, a mirror or other beam steering device. The control system can comprise a controller or computer that controls a modulator capable of periodically coupling photons from at least one of the first or second emitter to the trapping region. In one aspect of a system or method of the invention, at least one of the first or second emitter can comprise modulating between at least one of the first and/or second emitter.

In one aspect, the modulator of the system is capable of optically associating with photons emitted from at least one of the first or second emitter. For example, the modulator can be a device or member that can mechanically or otherwise physically be in contact with and, for example, decouple emitted photons of the first or second emitter from the trapping region. Similarly, for example, the modulator can interrupt or chop photons before they enter the trapping region. Decoupling, chopping or interrupting emitted photons, as well as other suitable approaches, can also occur periodically. The modulator is also capable of periodically coupling photons emitted by at least one of the first or second emitter to the trapping region. In another aspect of the system, the modulator is coupled to at least one of the first emitter or the second emitter. For example, the modulator can be electronically coupled to at least one of the first or second emitter.

A modulator coupled to at least one of the first or second emitter can, for example, be used to periodically couple photons emitted by at least one of the first or second emitter to the trapping region. The modulator can, for example, be electronically coupled to an emitter or shuttering means for an emitter to duty-cycle, or power on and off, at least one of the first or second emitter. Preferably, a modulator of the system is operable to enable photon beam shuttering from at least one of the first or second emitter. The invention contemplates any systems which facilitate or carry out photon beam shuttering. Exemplary systems can include “pulse pickers” using acousto-optic deflectors (AODs), Bragg cells, electro-optic devices such as Pockels cells, physically chopping, directly triggering the first or second emitter or combinations thereof.

The above exemplary means of photon shuttering can also be performed in conjugation with, or independently by, duty cycling. In one embodiment, the system also comprises a second modulator that can be equivalent to or different from that of the above described modulator. The second modulator is preferably capable of optically associating with photons emitted from at least one of the first emitter or the second emitter, or is coupled to at least one of the first emitter or the second emitter. The second modulator can have any or all of the characteristics of the first modulator described above. For example, the second modulator is capable of synchronously operating with the modulator to periodically couple photons emitted by at least one of the first emitter or the second emitter to the trapping region.

In one aspect of the invention, the second modulator of the system is operable to enable photon beam shuttering from at least one of the first or second emitter. The invention contemplates systems which facilitate or carry out photon beam shuttering. Exemplary systems can include “pulse pickers” using acousto-optic deflectors (AODs), Bragg cells, electro-optic devices such as Pockels cells, physically chopping, directly triggering pulsed laser sources or combinations thereof. In one embodiment, the system of the invention comprises a modulator capable of periodically coupling photons emitted by the second emitter to the trapping region. For example, the modulator can be capable of optically controlling photons emitted from the second emitter, or it can be coupled to the emitter itself or a shutter for the emitter.

Preferably, the second modulator of the system of the invention is capable of periodically coupling photons emitted by the first emitter to the trapping region. For example, the second modulator can be capable of optically associating with photons emitted from the first emitter, or coupled to the emitter itself or a shutter for the emitter. In one embodiment, the first and second emitter of the system of the invention can be laser sources. For example, the laser sources can be any conventional type of laser source. Preferably, the first emitter is a laser source for optical trapping. Similarly, the second emitter can be a laser source for excitation such as, for example, for microscopy. Such microscopy can be luminescence or fluorescence type microscopy.

In one aspect, the system of the invention can be used to carry out force-luminescence and/or force-fluorescence microscopy of a target. For example, a target can be trapped, positioned, controlled, manipulated, moved or the like and combinations thereof by the first emitter. Preferably, the first emitter is capable of carrying out optical trapping or “tweezing” as appreciated by those of ordinary skill in the art. In one aspect, the first emitter can impart forces to a target substantially or completely in the formed optical trapping region.

The present invention also provides a method for force-luminescence and/or force-fluorescence microscopy. In one embodiment, the method comprises providing a system of the invention. The method also comprises periodically coupling photons emitted by at least one of the first emitter or the second emitter to the trapping region via the system. In another embodiment, a method of the invention comprises periodically coupling photons emitted by at least one of the first emitter or the second emitter to the trapping region so as to perform alternating excitation of and photon force imparting to a target. For example, a method of the invention can comprise emitting photons periodically from the first emitter and the second emitter of the system into the trapping region and imparting photon forces to a target in the trapping region, followed and/or preceded by fluorescence of the target.

A method of the invention can further comprise providing excitation of the target and alternating imparting photon forces to and excitation of the target. The method can also comprise carrying out force-luminescence microscopy of a target or force-fluorescence microscopy of a target.

A system of the invention can be used to carry out force-microscopy of coincident parts of a target. Preferably, the system of the invention can be used to carry out force-fluorescence of a target. The target subjected to, for example, force-luminescence can be substantially or completely in the trapping region formed by the first emitter of a system of the invention. Exemplary targets include, without limitation, compounds, synthetic or natural compounds, molecules, biological molecules and so forth as well as combinations thereof.

Such targets can also be individual compounds, synthetic or natural compounds, molecules, biological molecules and so forth as well as combinations thereof. The invention also contemplates targets that are biological molecules comprising nucleic acids, amino acids, deoxyribonucleic acids, ribonucleic acids and so forth and any combinations thereof. Similarly, such targets can be any biological, chemical, physical events and/or interactions and so forth as well as combination thereof. An exemplary event includes chemiluminescence, fluorescence, or fluorescence resonance energy transfer (FRET). Moreover, such targets can be samples of any biological or chemical materials and/or assays or combinations thereof.

Exemplary targets can also include genes, proteins, tissues, cells, fluorophores, chromophores and so forth as well as combinations thereof. A target can also be a particle or particles such as, for example, any nanoparticle, dielectric particles or nanoparticles. For example, in the trapping region, refractive optical forces can constrain small dielectric particles, allowing the application of calibrated force and manipulation of, without limitation, small beads or individual cells. In one aspect, a system or method of the invention is well suited for evaluating the molecular events that initiate from an external mechanical stimulus of a target such as, for example, a cell, although many other types of evaluations can be performed by a system or carrying out a method of the invention. In another aspect, a system or method of the invention can be used for a broad range of single molecule and cellular mechanical evaluations as well as binding evaluations. Any target, such as those indicated by way of example herein, can also be conjugated or labeled such as can be appreciated by those of ordinary skill within the art.

### DESCRIPTION OF THE DRAWINGS

Other features and advantages of the invention may also be apparent from the following detailed description thereof, taken in conjunction with the accompanying drawings of which:

FIG. 1 is an exemplary representation of a system of the invention;

FIG. 2A is a preferred embodiment of a system of the invention;

FIG. 2B is another preferred embodiment of a system in accordance with the invention;

FIG. 3 is an exemplary representation of a system of the invention;

FIG. 4 is an exemplary representation of a system of the invention;

FIG. 5 shows an exemplary method according to the invention;

FIG. 6 shows plots in which the lifetime of a fluorophore candidate is extended using a system of the invention operating with duty cycling as plotted;

FIG. 7 shows exemplary out of phase shuttering for a system of the invention;

FIG. 8 are images demonstrating fluorophore bleaching observed when using a system of the invention operating under in-phase and synchronously switched (out-of-phase) pulsed modes;

FIGS. 9A-9C shows plots of the relationship of optical trapping power and chopping frequency and trap stiffness for a system of the invention;

FIG. 10 shows a plot of out of phase chopping for a system of the invention;

FIG. 11 shows a plot of exemplary bead position in relation to normalized trap power at a frequency of 750 Hz with stokes flow for a system of the invention;

FIG. 12 shows plots for a system of the invention employing no trapping (left), trapping with the excitation source and first emitter in phase (center), and trapping with the excitation source and first emitter out-of-phase (right), wherein a chopping frequency of 50 kHz is used;

FIG. 13 shows a plot of normalized fluorescence counts versus time for a system of the invention operating under the exemplary identified conditions for Cy3 bulk beads;

FIG. 14 shows a plot of normalized fluorescence counts versus time for a system of the invention operating under the exemplary identified conditions for TMR bulk beads;

FIG. 15 shows a plot of normalized fluorescence counts versus time for a system of the invention operating under the exemplary identified conditions for Alexa555 bulk beads;

FIG. 16 is an energy-level diagram modeling three parabolic energy wells for a target molecule, such as a fluorophore, showing the normal fluorescence pathway and the photodestruction pathway that can result from in-phase combination of the excitation and optical trap photon flux densities forcing the molecule to higher energy states, from which potential photodestruction can occur through ionization, triplet states and other decay pathways.

FIG. 17 shows histograms of Cy3 fluorophore lifetimes for single molecule observations when using a system of the invention operating with modulation out of phase and in phase, wherein out of phase modulation demonstrates about a 20 fold improvement lifetime increase as compared to in phase modulation;

FIG. 18 shows plots of exemplary bead position versus time for different modulation frequencies from about 50 kHz to about 750 Hz for a system of the invention;

FIG. 19 shows a plot of variance versus frequency for continuous trapping versus modulating trapping using a system of the invention for the different frequencies of the plots in FIG. 18;

FIG. 20 shows plots of polystyrene bead positions versus time for different modulation frequencies from about 50 kHz to about 750 Hz at a fluid velocity of 400 μm per second for a system of the invention;

FIG. 21 shows a plot of average bead position versus frequency for continuous trapping versus modulating trapping using a system of the invention for the different frequencies of the plots in FIG. 20; and

FIG. 22 is an exemplary representation of a system of the invention;

FIG. 23 is a fluorescence resonance energy transfer (FRET) measurement illustrating energy transfer associated with the opening of a single hairpin of DNA; and

FIGS. 24A-24C schematically illustrates a measurement of a trapped bead using the interlaced modulation of the present invention.

### DETAILED DESCRIPTION

The systems and methods of the invention relate to periodically and synchronously switching between photon beams from at least two emitters that are each projecting photons into an optical trap region.

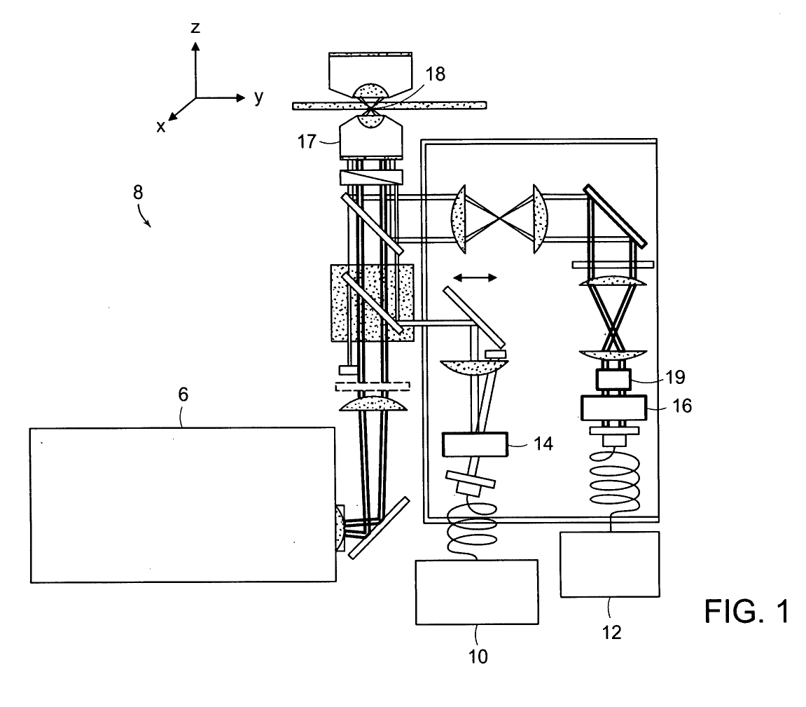

In a preferred embodiment of the invention, referring to FIG. 1, a system 8 is provided wherein a first emitter 12 is a laser for forming an optical trap in trapping region 18 when sufficient photons from the first emitter 12 reach the trap region to achieve trapping. In such a preferred embodiment, a second emitter 10 is controllably coupled with a modulator 14 such that the second emitter 10 can project a minimum photon beam amplitude (or flux density) into the optical trap region 18 during time periods when the optical trap emitter 12 is projecting a maximum photon beam amplitude (or flux density) into the optical trap region 18.

Still referring to FIG. 1, a preferred embodiment further provides a system 8 having an optical trapping region 18 and a laser emitter 12 for forming an optical trap in the trapping region 18, wherein optical coupling components (such as, inter alia, lenses, shutter, mirrors, dichroic reflectors and apertures) are used to optically couple the laser emitter 12 to the optical trapping region 18 so that the projected photons form a focal point in the trapping region 18, and wherein there is provided a modulator component 16 (and/or similar switch) that can periodically turn the optical trapping beam “on” and “off”, and wherein such modulator 14 can also provide optical steering of the optical trap.

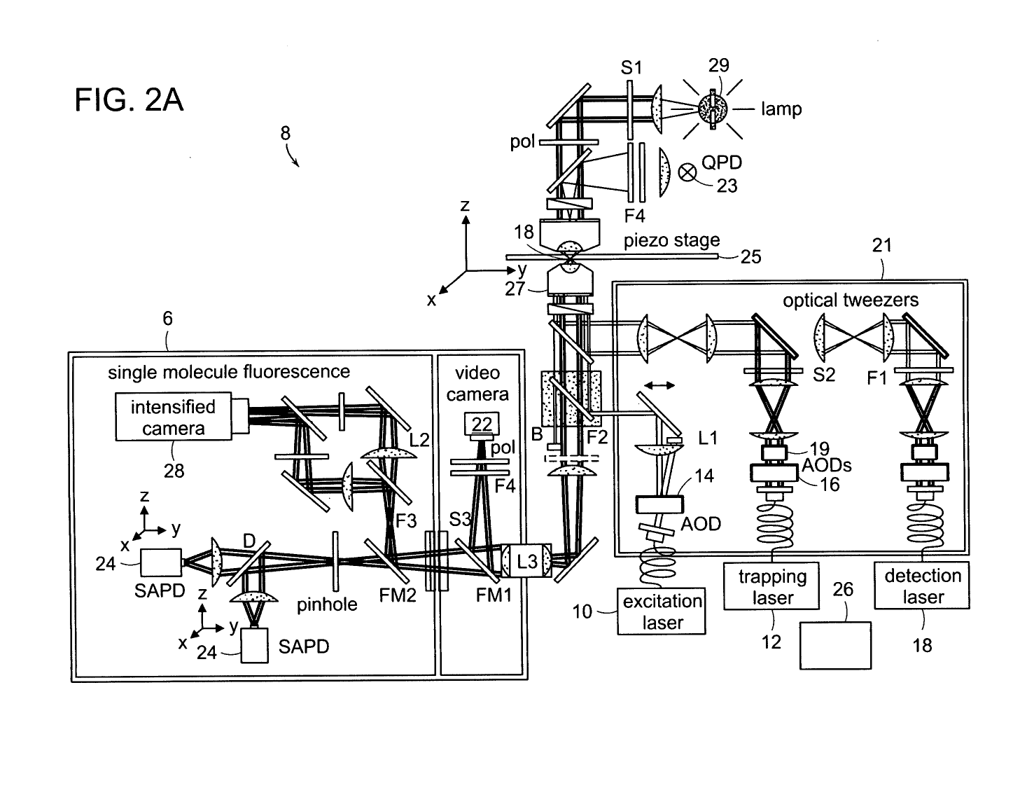

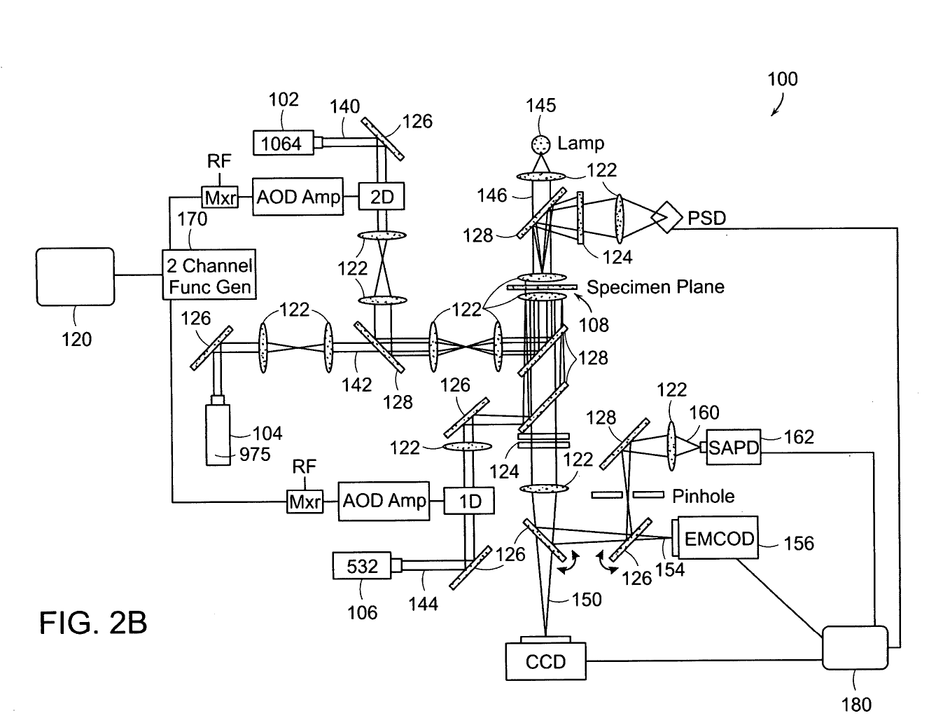

Referring to FIG. 2A, another preferred embodiment of the invention provides for a system 8 that further comprises a modified Nikon TE2000 inverted microscope 27 with a nano-positionable three dimensional piezo stage 25, mercury arc lamp 29, and a quadrant photodiode (QPD) subsystem 23 used to detect changes in the position of the trapped target. The input optics 21 include an excitation laser 10, trapping laser 12 and detection laser 18. The position-detection pathway is shown in orange, the trapping-laser pathway in red, the fluorescence-excitation pathway in blue and the fluorescence-emission pathway in dark green. The microscope transillumination pathway is shown in light green. The trapping laser beam can be moved electronically and automatically by means of acousto-optic def lectors (AODs) 16 and 19 placed at optical planes conjugate to the back focal plane of the objective. The output optics 6 include a cooled, intensified charge-coupled device (CCD) camera 28, a conventional black-and-white CCD camera 22 and two silicon avalanche photodiodes (SAPDs) 24. The identities of other optical elements in FIG. 2 include: B, beam; D, dichroic, F, filter; L, lens; P, polarizer; S, shutter; and FM, flipper mirror. AOD modulator components 16 and 14 provide temporal, cyclic control of the trapping beam and the fluorescence excitation beams, respectively. In a further preferred embodiment, AODs 16 and 14 are controlled by a common modulation timing controller 26, such as, for example, a function generator. It should be appreciated by one of ordinary skill in the art that modulation timing controller 26 can alternatively include, according to the invention, clocks, synchronators, oscillators, micro-controllers, A-to-D controllers or any appropriate timing device that can produce two signals at desired phase separation and frequencies.

In one embodiment, the stage 25 comprises microfluidics. Exemplary microfluidics can include, without limitation, microfluidic substrates, cells, tubes, ports and so forth and any combinations thereof. Such microfluidics can also comprise, for example, wells, channels, loading regions, loading ports, flow control channels, nutrient channels, mixing and reaction zones, recovery wells, arrays and combinations thereof. Exemplary microfluidics can also comprise silicon or other semiconductor materials such that a first emitter of a system of the invention can form an optical trap through or substantially proximate to the microfluidic or a plurality of microfluidics, which can include, for example, wells, channels, loading regions, loading ports, flow control channels, nutrient channels, mixing and reaction zones, recovery wells, arrays and combinations thereof.

A preferred embodiment of the invention also provides a method for reducing enhanced fluorophore photobleaching caused by photon flux in the optical trapping region. For example, a system can reduce such photobleaching by switching between (which can also be termed chopping, periodically alternating, synchronously switching, switch-pulsing, modulating out-of-phase, interlacing and so forth) the high flux trapping beam and the lower-intensity fluorescence laser.

Chopping frequency can be chosen to avoid loss of optical force while preventing overexposure of the fluorophores to photon flux density. The frequency can be set to be within the accessible range of the acousto-optic modulators yet, preferably, much higher than the frequency at which viscous drag dominates the motion of a trapped bead, commonly referred to as the Lorentzian roll-off frequency. In preferred embodiments, control circuitry shutters both beams at rates in the range of 10 kHz to 250 kHz, with a controllable duty cycle and amplitude, providing high repetition rate beam alternation that does not interfere with the force of the trap, yet significantly improves (reduces) the bleaching effect that is observed during continuous trapping and fluorescent excitation.

According to a preferred method, the basic path for turning on and off the beams is to start with an RF frequency source operating at approximately 26 MHz (so as to appear as a sine wave) and then to pass this signal into an RF amplifier, which increases the peak-to-peak voltage of the sine wave, but preserves the frequency. Then, this amplified signal is sent into the AOD crystal which uses the amplified RF signal to form a periodic pressure wave in the crystal. This pressure wave then causes a laser beam propagating through the crystal to produce additional deflected beams, owing to diffraction of these beams.

When an RF frequency acoustic wave propagates inside an optically transparent medium, a periodic change in the refractive index occurs, owing to the compressions and rarefactions of the sound wave. This periodic variation produces a grating capable of diffracting an incident laser beam. The angles of the deflected beams are proportional to the input RF frequency (which changes the spacing of the pressure waves in the crystal). Thus, in operation, a preferred embodiment of the method includes isolating one of the deflected beams, blocking the original, fundamental beam and any other deflected beams, and projecting the isolated beam into the microscope objective. Changing the RF frequency source slightly changes the angle of the isolated deflected beam, so as to steerably move the optical trap.

In a system 8 according to a preferred embodiment of the invention, it is convenient to interface with AODs. Switching off the RF signal completely removes the deflected beams in the crystal and, thus, turns the trap (or fluorescence beam) off. An alternative preferred embodiment provides for changing the beam to a different location so that the beams do not go into the objective, or are far enough away from the previous focal point to lower the flux density impinging on the optical trapping region.

A preferred method of the invention provides for turning the deflected beams off by removing the RF signal prior to the amplifier. To accomplish this, a preferred method of the invention incorporates a mixer between the RF frequency source and the RF amplifier or, alternatively, a switch is used at this location. Both of these can be controlled with a function generator producing square pulse-like waves that have high and low voltage states, although other timing apparatuses can also be used. For the mixer, if the voltage of the high state and the low state are set properly, then the original RF signal passes through or the signal has no RF amplitude; thus, this arrangement operates as an on/off switch. For the switch, the high or low state (TTL pulse) will choose between two inputs, the normal RF signal or a dummy RF signal, that is provided with no RF amplitude. After the mixer or switch, the signal goes to the RF amplifier and then to the AODs.

For turning the optical trap on and off, in a preferred embodiment, the AODs that are used to move or steer the trap can also be used to stop the beam completely, thus shutting down the trap. In a preferred embodiment, another AOD crystal, frequency source and amplifier can be provided for the excitation laser and a first-order deflected beam is made to be a beam that projects into the microscope for excitation.

To control both AODs (and thereby both the trap and excitation beams simultaneously) with relative phase control, a preferred method uses a commercial, two-channel function generator. The clock frequency of the generator and relative phase between the signal outputs of the first channel and second channel correspond to the synchronous switching frequency and relative phase of the two AOD-controlled beams, respectively. The relative phase can be verified optically before the two beams enter the microscope by sampling with a photodetector, so as to make sure that the beams are 180 degrees out-of-phase; the phasing can also be automatically corrected and adjusted by such feedback. The durations of the first channel and second channel are set to a percentage of the overall time between clock periods. In one preferred embodiment, 50% of the available cycle time is taken and devoted to the trap being “on”. Another 30% of the time between clock periods is devoted to the fluorescence beam being “on”. The remaining 20% is dead time when both beams are in the “off” state. It will be appreciated by one of ordinary skill in the art that the relative durations can be altered in alternative embodiments of the invention.

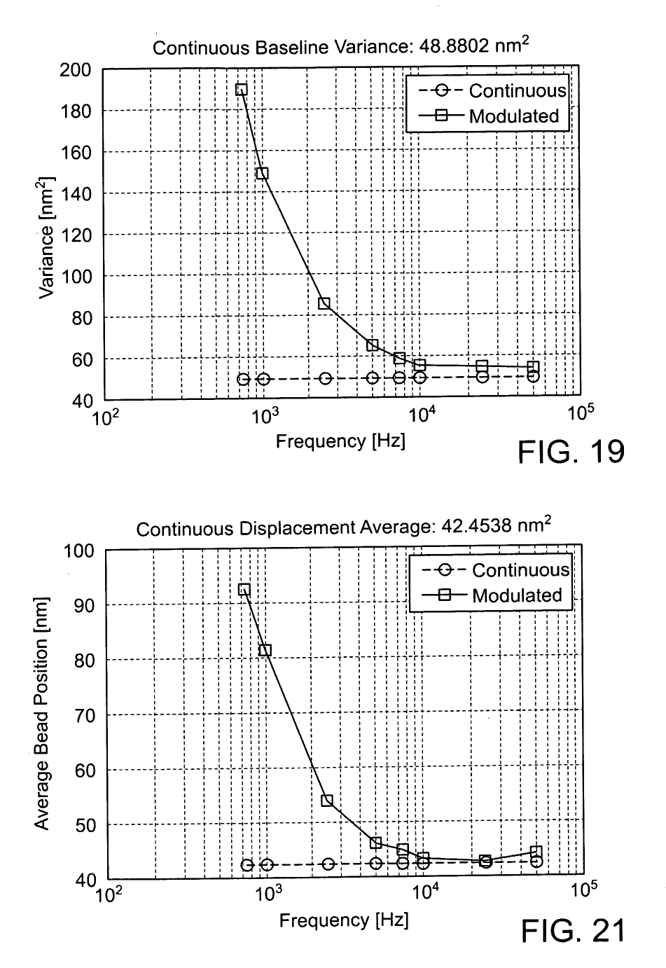

A preferred embodiment of a method of the invention provides for synchronously chopping or switching between modes for optical trapping and modes for fluorescence measurement, thus avoiding periods of time when both trap and excitation modes are “on” simultaneously. Switching is done rapidly, typically in the frequency range of 1 kHz to about 400 kHz, and preferably in the range of about 10 kHz to 250 kHz, so that both optical trapping capability and fluorescence imaging are maintained (see, for example, FIG. 19 and FIG. 21). A number of methods exist for controlling the light beams at these frequencies. A preferred embodiment utilizes acousto-optic deflectors (AODs) to turn off and on the beams.

A preferred method of the invention can include the steps of producing an RF signal, amplifying the RF signal and sending the RF signal into the acousto-optic deflector (AOD) modulator. The deflector can contain a piezoelectric element (such as, for example, Lithium Niobate piezoelectric transducers), that applies a pressure or sound wave to the optical crystal portion of the AOD (such as, for example, high quality flint glass) that can travel through the crystal. Since this sound wave is periodic, it can also be used to form additional beams, such as higher order beams that are due to diffraction of these beams.

A preferred embodiment provides for a method that continues by sending the laser into the crystal. The output comprises beam propagation where the laser can go and a set or plurality of other beams that have slightly different angles relative to the fundamental beam, so that they can be described as deflected beams.

If there is no pressure wave, then the crystal acts as a window and the beam passes without producing any deflected beams. However, if the sound wave is weak, then the deflected beams are weak, too. An example of the acoustic velocity is ˜4.2 mm/μs. Any change in the acoustic signal must travel through the beam diameter. This relationship can put a limit on the frequency modulation (switching a beam on and off) with an AOD. In a preferred embodiment, a small beam diameter is used, such as in the preferable range of 0.5 to 3 mm, and, most preferably, close to 1 mm, which is able to achieve modulation of around 200 kHz. Yet another preferred embodiment of the invention provides for a beam diameter of about 2 mm, which can be modulated effectively at about 50 kHz. A preferred embodiment, therefore, can provide for increasing the switching modulation frequency by placing the AODs at a location in the optical path where the beam is narrow, e.g., near a focus in the optical path.

The AOD for the first emitter can be used to move the trapping focal point. This is accomplished by changing the RF frequency, which is typically 26 MHz, to a slightly different frequency, such as 26.5 MHz. The change in the angle of the deflected beam can cause a translation of the beam in the specimen plane within the trapping region. In one embodiment, only the deflected beams go into the microscope objective. The other beams, including the fundamental beam (the only beam that would be present if the AOD were to be removed from the laser path) are blocked with a physical barrier (such as an iris).

In order to turn the beam on and off, a preferred method provides for simply removing the RF signal (e.g., giving it zero amplitude), thus removing periodic pressure waves and removing the diffraction of the beam within the AOD. The angular position of the first-order beam (the deflected beam) is proportional to the acoustic frequency. A further preferred embodiment provides for two AOD components 16, 19 placed sequentially in the optical trapping beam to each deflect the beam along separate x and y axes, in order to provide at least two dimensions of steering of the focal point of the optical trap within the trapping region.

A preferred embodiment of the invention provides for a method to interface fluorescence measurements with optical trapping measurements in a manner that reduces fluorophore destruction. Owing to the intense photon flux of an optical trap and other processes, fluorophores can often experience destructive interference in the optical trap regions, reducing fluorophore lifetimes (see FIG. 16). A preferred embodiment of the invention provides a system and method to reduce fluorophore destruction while maintaining optical trapping capability.

Further aspects of for forming an optical trap are described by way of example in U.S. Application entitled, “OPTICAL TRAPPING WITH A SEMICONDUCTOR,” filed Sep. 22, 2006, by David Appleyard and Matthew Lang, which is hereby incorporated by reference herein in its entirety. Other conventional mirrors, amplifications, lenses, and so forth, as well as any combinations thereof, such as is shown in the figures by way of example only, can be used with a system or method of the invention as well as any other suitable optical means, equipment components, devices and so forth as would be appreciated by one of ordinary skill within the art. Other systems and methods that can be used in conjunction with the present invention are described in “Interlaced Optical Force-Fluorescence Measurements for Single Molecule Biophysics,” Brau et al., Biophysical Journal, volume 91, August 2006, pages 1069-1077, the entire contents of which is incorporated herein by reference.

The invention also contemplates, for example, force-fluorescence in microfluidic applications. Such applications can employ any suitable type of microfluidic for a given application. Exemplary microfluidics can include, without limitation, microfluidic substrates, cells, tubes, ports and so forth and any combinations thereof. Such microfluidics can also comprise, for example, wells, channels, loading regions, loading ports, flow control channels, nutrient channels, mixing and reaction zones, recovery wells, arrays and combinations thereof. Exemplary microfluidics can also comprise silicon or other semiconductor materials such that a first emitter of a system of the invention can form an optical trap through or substantially proximate to the microfluidic or a plurality of microfluidics, which can include, for example, wells, channels, loading regions, loading ports, flow control channels, nutrient channels, mixing and reaction zones, recovery wells, arrays and combinations thereof.

A preferred embodiment provides for a system with advantageous position resolution, single-molecule detection sensitivity and force exerting capabilities. The position resolution can be measured by fixing a dielectric bead to the surface of a coverslip mounted on the microscope stage, followed by automated stepping of the stage drivers with piezoelectric actuators having calibrated 5 nm steps. The response demonstrates a measurement resolution of better than 2 nm and a calibrated trap stiffness of 0.2 pN/nm in a preferred embodiment of the system, measured through an infrared-optimized microscope objective. Independent from position measurement, sensitivity to single molecule fluorescence can be verified by observation of individual dyes that are immobilized on a coverslip surface and imaged on an intensified CCD camera.

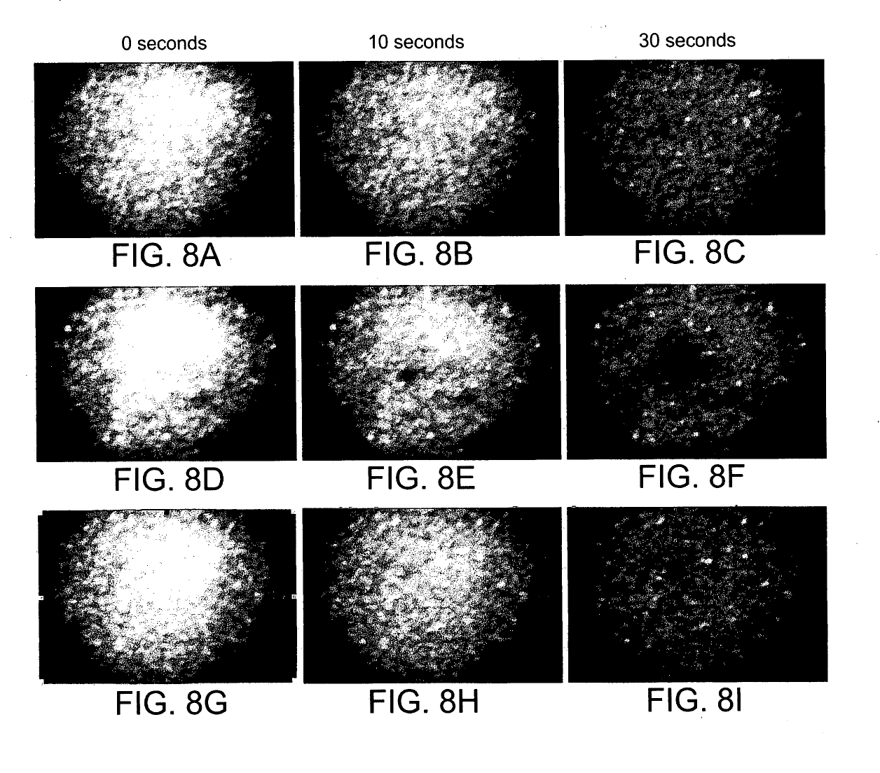

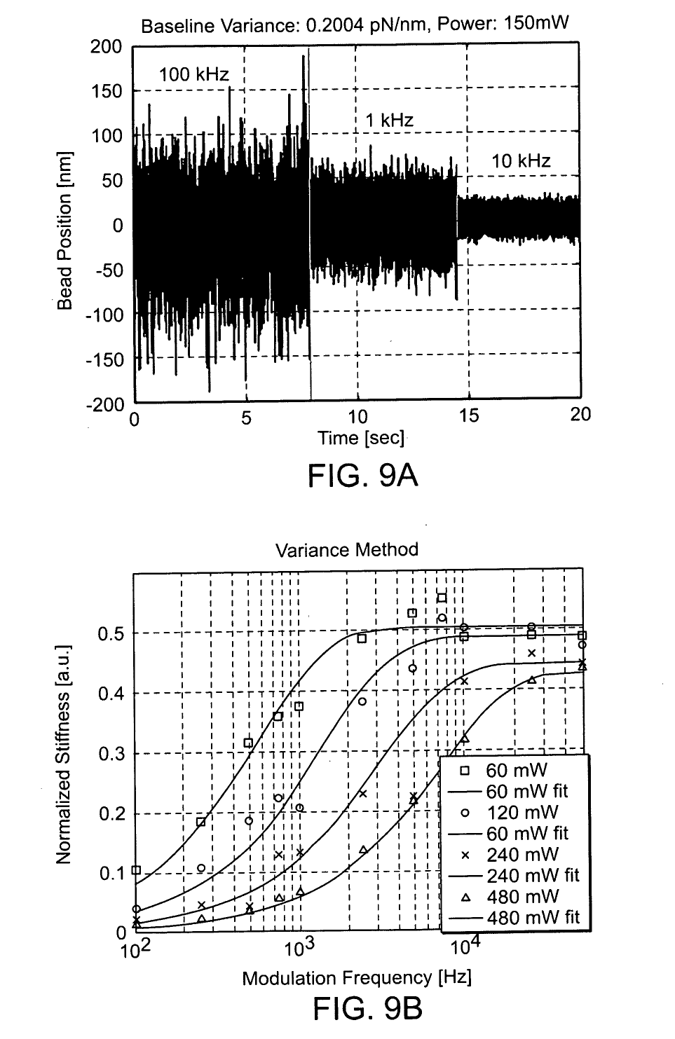

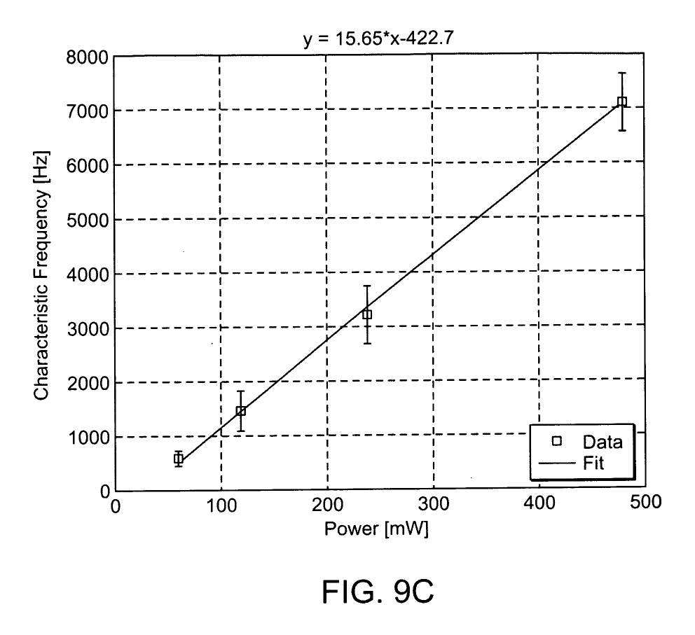

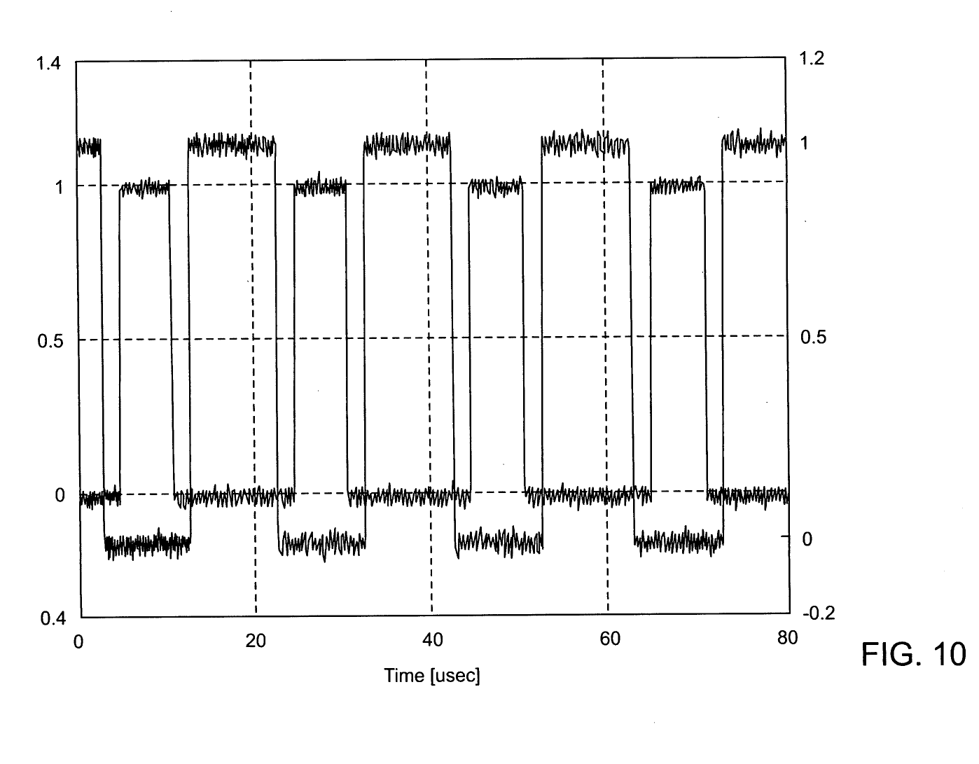

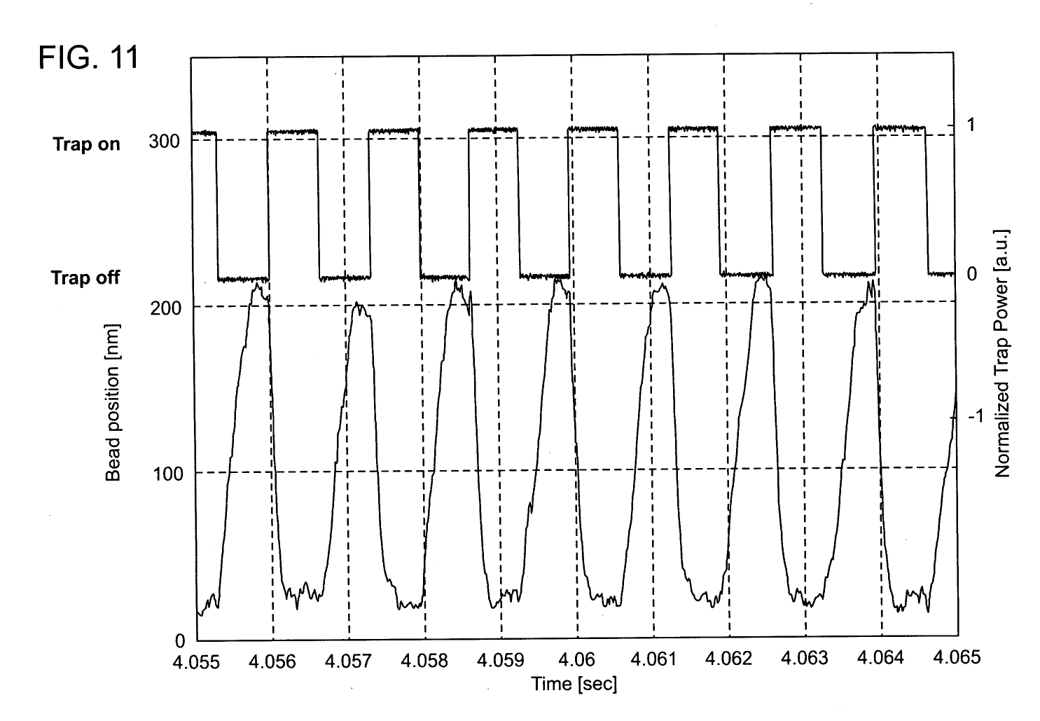

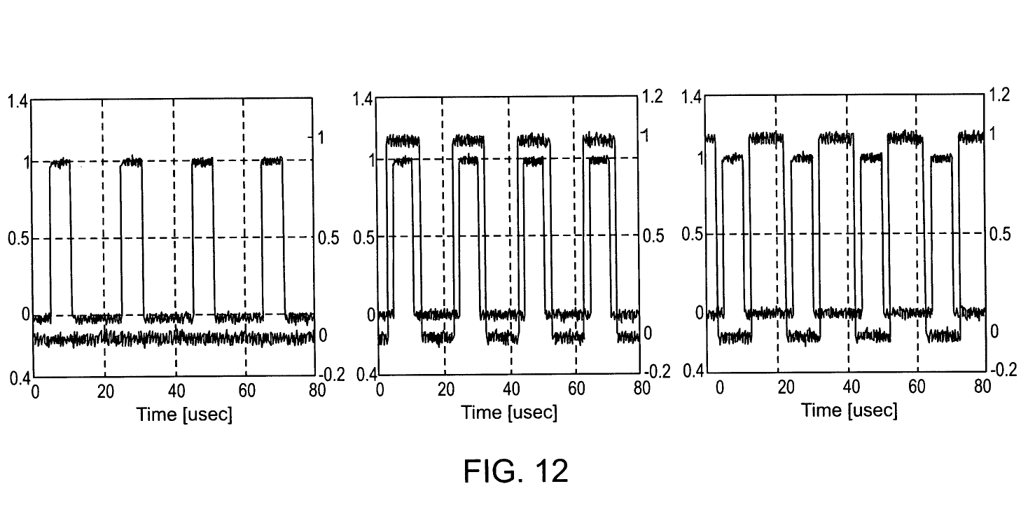

Preliminary examination of the effect of optical switching on both the trap force and the fluorophore lifetimes employed individual Cy3 dye molecules immobilized on the support surface of a glass coverslip and Cy3 coated beads trapped in an excitation zone. The intensity of the trap beam was adjusted to provide photon flux similar to that of a typical optical trap, and fluorescence excitation was set to an intensity typical used in single molecule spectroscopy applications. Ensemble lifetime extension hole-burning tests on the immobilized dye molecules, shown in FIG. 8, revealed a dramatic improvement in fluorophore Longevity.

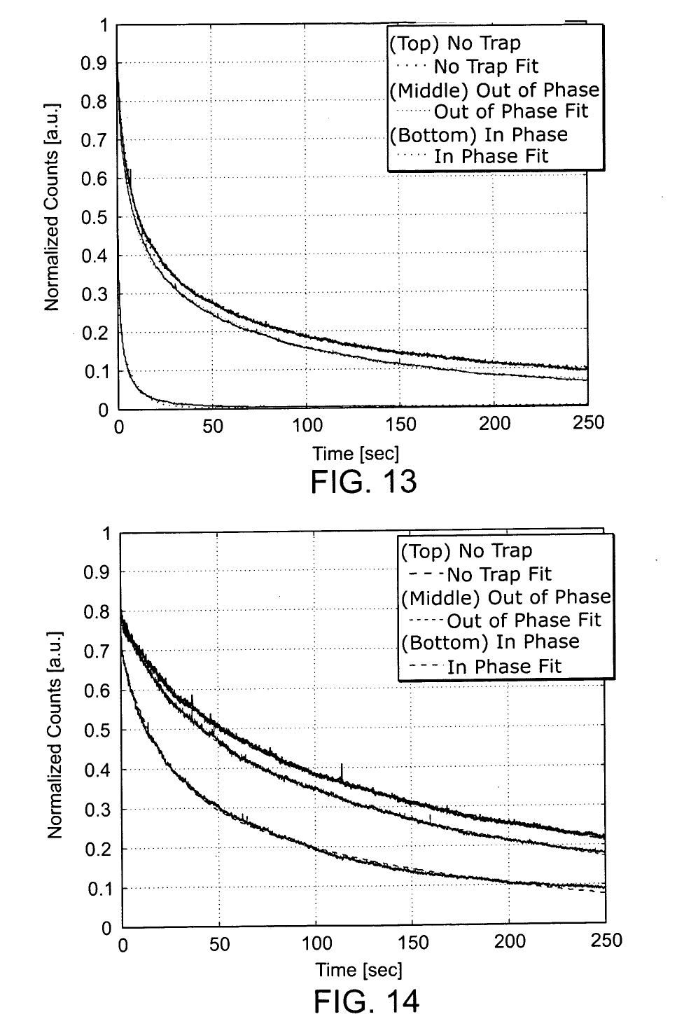

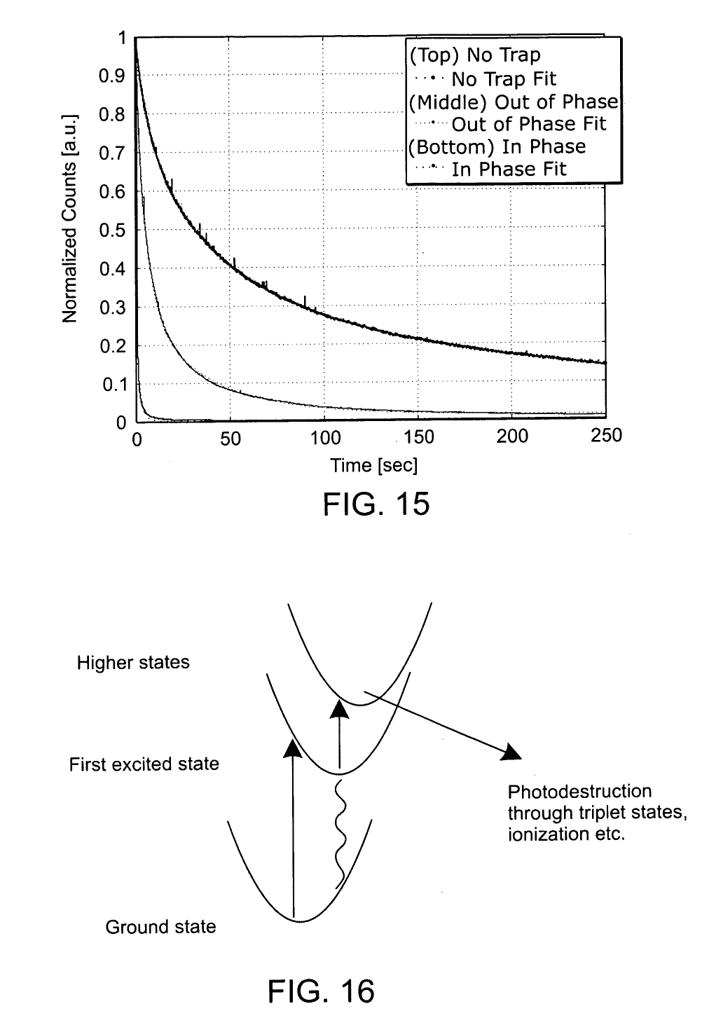

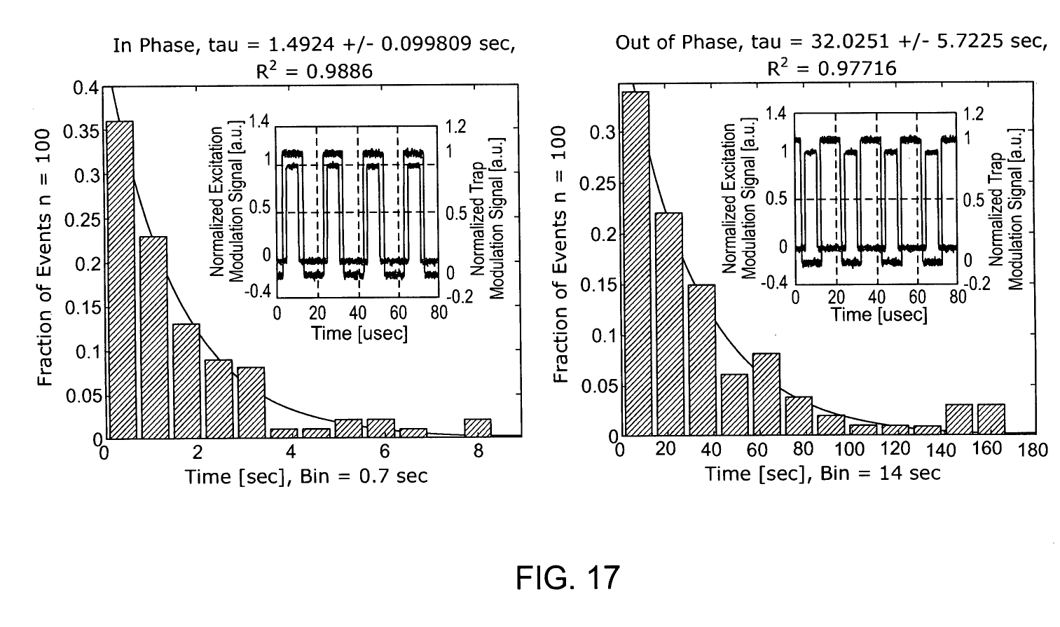

Performance of a preferred embodiment of the invention has been evaluated, where measurements on trapped, dye-labeled bead have quantified the temporal lifetime extension of bulk beads (see FIGS. 13-15 and FIG. 17), showing lifetime improvement on the order of tens of seconds in fluorophore emission. These evaluations, which use 50 kHz chopping with a 40% duty cycle, demonstrate advantages of the invention in regard to sufficiently extend fluorophore lifetimes for single molecule experiments combining optical trapping and fluorescence.

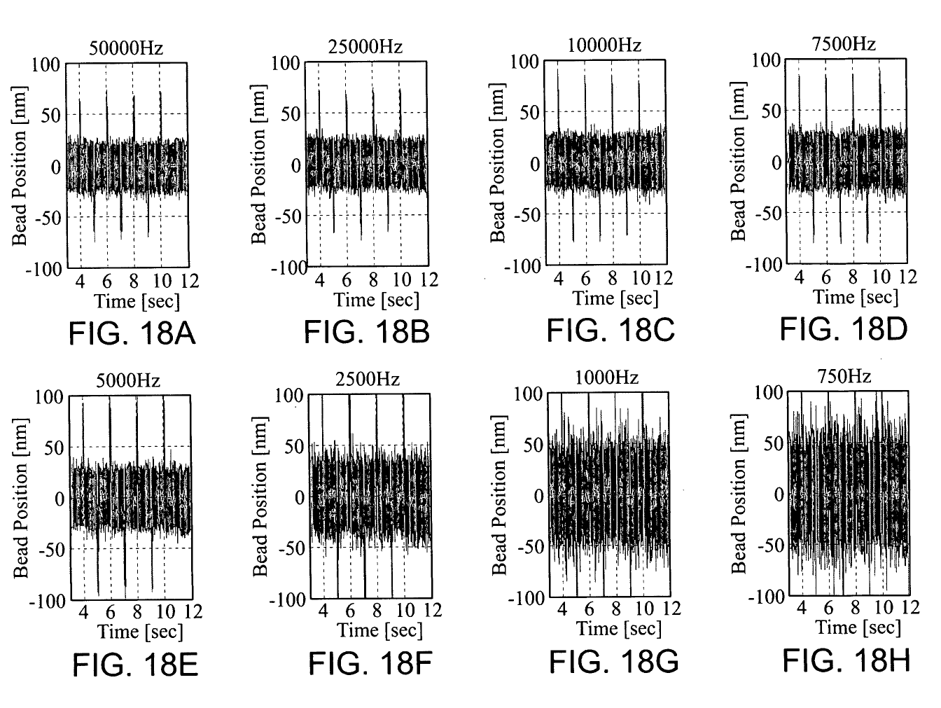

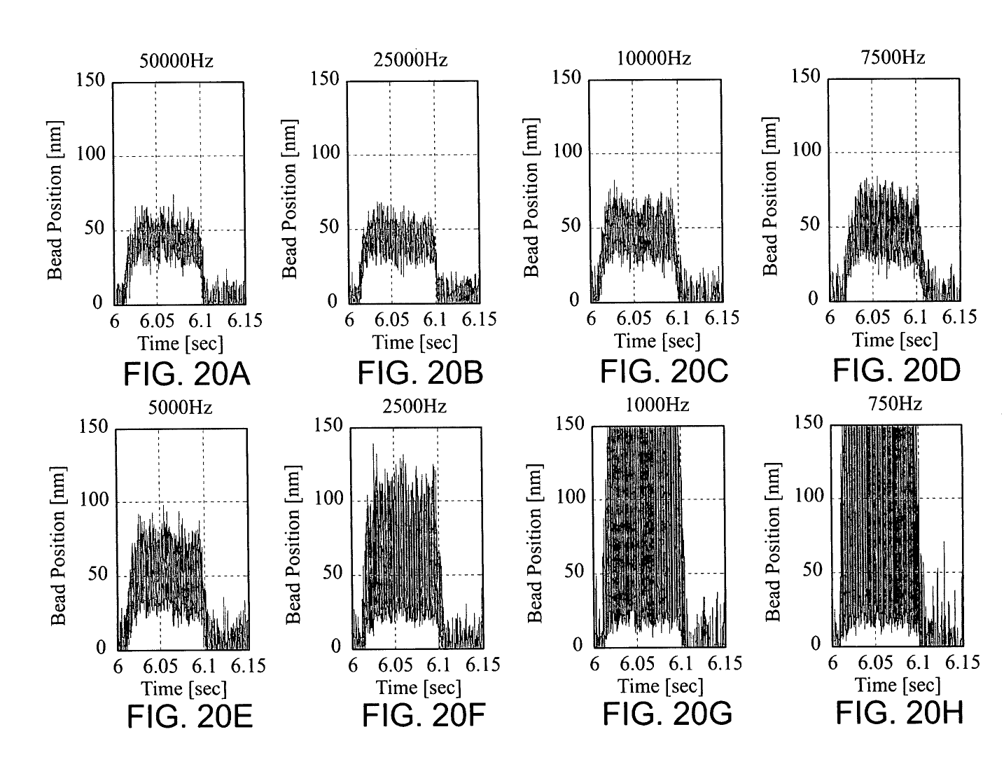

Performance evaluations at differing frequencies also verified that the switching technique of the invention does not compromise the force exerting capabilities of the trap; particularly, at the preferred frequencies of 10⁴ Hz and greater, the trapped bead effectively resists sustained loads applied by Stokes fluid flow (See FIGS. 18-21).

A preferred embodiment provides for a system that achieves both the precise positioning necessary for application of the desired mechanical forces at micro-scales, and broad application to a variety of choromophores that would otherwise experience destructive photophysics in the high photon flux optical trapping region. Advantages of preferred embodiments of the invention also include providing a method for simultaneous trapping and fluorescence imaging wherein fluorophores are three to ten times less likely to be destroyed in the presence of optical trapping.

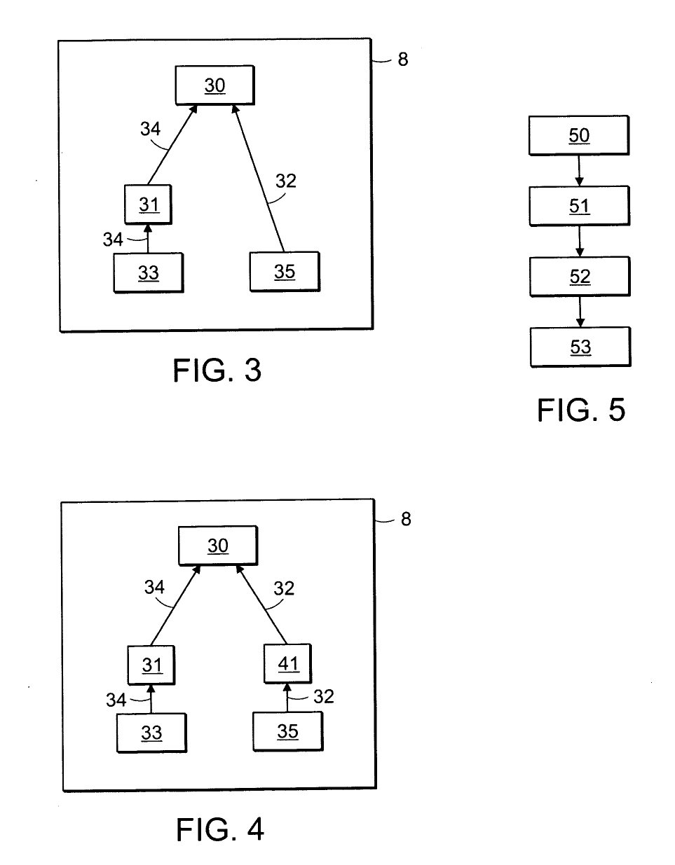

A system of the invention can be used in order to prevent the enhanced photobleaching effect caused by high photon flux in an optical trap. A system and method of the invention can be used or carried out, respectively, to, for example, improve fluorophore lifetimes. In one embodiment, the present invention provides the system shown in FIG. 3. As shown, the system 8 comprises a first emitter 35. The first emitter is capable of emitting photons to form a trapping region 30. Photons emitted from the first emitter form an optical path or beam 32 so as to optically couple the first emitter 35 to the trapping region 30.

FIG. 3 also shows a second emitter 33 of the system 8. The second emitter 33 is capable of emitting photons into the trapping region 30. For example, photons emitted from the second emitter 33 form an optical path or beam 34 so as to optically couple the second emitter 33 to the trapping region 30. As shown, a modulator 31 is optically associated with photons emitted from the second emitter 33. For example, the modulator is optically associated with photons along optical path or beam 34. Alternatively, a system of the invention can comprise a modulator 31 optically associated with photons emitted from at least one of the first emitter or the second emitter. In another embodiment of the invention, the modulator can be coupled such as, for example, by electronic means to at least one of the first emitter or the second emitter.

Another preferred embodiment of a combined optical tweezers and single molecule fluorescence instrument 100, shown in FIG. 2B, is based on a modified inverted microscope. This device combines separate lasers for optical trapping 102 (1064 nm; Coherent, Santa Clara, Calif.), position detection 104 (975 nm; Corning Lasertron, Bedford, Mass.), and fluorescence excitation 106 (532 nm; World Star Tech, Toronto, ON) through a base that has improved mechanical stability, incorporated Nomarski optics, and a movable piezoelectric stage 108 (Physik Instrumente, Auburn, Mass.). In addition, the arrangement includes a pair of computer 120 controlled acousto-optic deflectors (AODs; IntraAction, Bellwood, Ill.) using a controller 170.

All lenses, including the objective and condenser, are displayed as ovals 122. Filters 124, mirrors 126, and dichroics 128 are represented as rectangles. Trapping 140 and detection 142 laser beams, 1064 and 975 nm, respectively, are guided into the objective and focused on the specimen plane to form an optical trap. The position of the trapped particle is monitored by spectrally isolating and imaging the detection laser on a PSD. Total internal fluorescence excitation, supplied by a 532-nm laser beam 144, is focused near the back pupil of the objective. Bright-field illumination 146 is provided by a mercury arc lamp 145, and images 150 are collected by a CCD camera 152. Fluorescence images 154 are collected by an electron multiplying CCD 156 (EMCCD), and single molecule fluorescence counts 160 are spatially filtered through a pinhole and acquired by an SAPD 162. The trapping and excitation lasers are modulated by AODs controlled with an electronic mixer (Mxr) that combines a preamplified radio frequency AOD drive signal with a square wave generated in a controller 170 such as a function generator which permit precise steering of the trapping beam in two dimensions, and remote-controlled flipper mirrors and shutters, which facilitate rapid switching between bright-field imaging (CCD camera; DAGE-MTI, Michigan City, Ind.) and high-sensitivity fluorescence detectors. The detectors are connected to a data processor 180 that processes the data and can provide feedback control to revise the operating parameters of the controller 170 and computer 120. The detectors can record the spectral response of the object to the excitation light along with position data of an object in response to the optical force applied to the object which can be as described previously or a tether or connector that is holding a trapped object.

Both the trapping and detection lasers are guided into the microscope objective (100×, 1.40 numerical aperture, oil infrared; Nikon, Melville, N.Y.) via a dichroic mirror (Chroma Technology, Rockingham, Vt.) that reflects only near-infrared light. The diameter of the trapping laser beam is adjusted with a telescope to slightly overfill the objective pupil to ensure high-efficiency trapping. After passing through the microscope condenser lens, the detection beam is spectrally isolated (Andover, Salem, N.H.) from the trapping beam and imaged on a position-sensitive device (PSD; Pacific Silicon, Westlake Village, Calif.) for back focal plane detection. This optical tweezers arrangement was calibrated using previously described procedures and is capable of trapping 500-nm-radius polystyrene beads with a stiffness of ˜0.1 pN/nm per 100 mW of unmodulated trapping laser power.

In addition to these force capabilities, the microscope is outfitted for objective-side total internal reflection fluorescence excitation and single-molecule emission detection. The excitation laser, which is controlled by an independent AOD (IntraAction), is guided through a customized optomechanical system that replaces the microscope's fluorescence turret. This modification, which allows for focusing and off-axis translation of the excitation laser along the back focal plane of the objective, is set directly below the trap-steering dichroic mirror. It consists of a filter cube (532-nm dichroic and 540-nm long-pass filter; Chroma Technology) and a KGS filter (Schott Glass, Elmsford, N.Y.) to reflect the excitation light into the sample, transmit fluorescence emission, and efficiently block scattered or reflected light from the excitation, trapping, and detection lasers. Transmitted fluorescence signals are imaged with either an EMCCD intensified camera (Andor Technology, South Windsor, Conn.) or a photon-counting silicon avalanche photodiode (SAPD; PerkinElmer, Wellesley, Mass.), which collects through a pinhole (ThorLabs, Newton, N.J.) conjugate with the specimen plane for the spatial signal isolation from background and bead scattering signals and a 628-nm dichroic mirror (Chroma Technology) for similar spectral separation.

To quickly modulate the intensities of both the trapping and excitation lasers, electronic mixers (Mini-Circuits, Brooklyn, N.Y.) multiply both preamplification AOD radio frequency signals with a square wave signal from a two-channel function generator (Tektronix, Richardson, Tex.). This technique is similar to a recently demonstrated fluorescence sorting method and to other trap modulation schemes. In essence, it temporally turns the trapping and excitation lasers on or off, allowing for their in-phase (IP) or out-of-phase (OP) synchronization. For all the experiments described in this report, the fluorescence excitation and trapping lasers were further modulated with a duty cycle of 30% and 50% and set to an average postmodulated power of 250 μW and 100 mW, respectively. In the OP condition, the pulses of the trapping and excitation lasers are aligned such that there is a 2-μs dark period in between pulses, as verified by a single photodiode (ThorLabs). The duration of the fluorescence excitation and trapping laser pulses are 10 and 6 μsec, respectively. For the IP condition, the phase of the trapping laser was shifted by 180°, placing the fluorescence excitation pulse squarely in the middle of the trapping laser pulse (see FIG. 3, insets). Custom software (LabView; National Instruments, Austin, Tex.) acquired all signals through a 16-bit A/D board (National Instruments) and automated all instrument components.

In another aspect, the system 8 of FIG. 3 comprises a first emitter 35 that is capable of being pulsed. Such pulsing of the first emitter 35 can be carried out by any suitable means such as, for example, means appreciated by those of ordinary skill in the art. In one embodiment, the first emitter 35 is pulsed and the modulator 31 is operable to periodically couple photons emitted by the second emitter 33 to the trapping region 30. In yet another aspect of the invention, the second emitter 33 can also be capable of being pulsed. Such pulsing of the second emitter 33 can be carried out by any suitable means such as, for example, means appreciated by those of ordinary skill in the art. In one embodiment, the first emitter 35 and second emitter 33 can each be pulsed synchronously so as to periodically couple photons emitted by at least one of the first emitter or the second emitter to the trapping region 30.

As described herein, the modulator 31 is operable to periodically couple photons emitted by at least one of the first emitter or the second emitter to the trapping region 30. As shown, the modulator 31 is operable to periodically couple photons emitted by the second emitter 33 to the trapping region 30. For example, the modulator can operate by mechanical or electrical means to interrupt the optical path or beam 34 from the second emitter 33 such that the emitter is decoupled from the trapping region 30. The modulator 31 can then enable recoupling the photons emitted by the second emitter 33 to the trapping region 30. This coupling and decoupling can be considered to be a periodic coupling of photons via an optical path to the trapping region. Such coupling and decoupling can also limit or prevent destructive photophysics originating from both the first emitter and the second emitter being “on” or emitting photons into the trapping region at the same time.

As shown in FIG. 3, the modulator 31 of the system 8 is capable of optically associating with photons emitted from the second emitter 33. For example, the modulator 31 can be a device or member that can mechanically or otherwise physically be in contact with and, for example, decouple emitted photons of the second emitter 33 from the trapping region 30. Similarly, for example, the modulator 31 can interrupt or chop photons before they enter the trapping region. Decoupling, chopping, interrupting or modulating emitted photons, as well as other suitable approaches such as the exemplary approaches described herein, can also occur periodically. As described herein, for example, the modulator can be electronically coupled to at least one of the first or second emitter.

A modulator 31 coupled to at least one of the first or second emitter can, for example, be used to periodically couple photons emitted by at least one of the first or second emitter to the trapping region. The modulator can, for example, be electronically coupled to an emitter to duty-cycle, or power on and off, at least one of the first or second emitter. Preferably, a modulator of a system of the invention is operable to enable photon beam shuttering from at least one of the first or second emitter. The invention contemplates any suitable means by which to facilitate or otherwise carry out photon beam shuttering. For example, the modulator in FIG. 3 can be based on principles or means of pulse picking using acousto-optic deflectors (AODs), Bragg cells, electro-optic devices such as Pockels cells, physical chopping, periodic beam steering direct triggering spatial light modulators, galvo steering mirrors, diffractive/holographic elements or combinations thereof. Such exemplary means of photon shuttering to decouple and then recouple an optical beam or path can also be performed in conjugation with, or independently by, duty cycling.

In another embodiment, a system of the invention also comprises a second modulator that can be equivalent to or different from that of the above described modulator referenced with regard to FIG. 3. The second modulator is preferably capable of optically associating with photons emitted from at least one of the first emitter or the second emitter, or coupled to at least one of the first emitter or the second emitter. The second modulator can have any or all of the characteristics of the first modulator described above. For example, the second modulator is capable of synchronously (out of phase) operating with the modulator to periodically couple photons emitted by at least one of the first emitter or the second emitter to the trapping region.

FIG. 4 shows a system 8 of the invention, wherein the system comprises a first emitter 35. The first emitter is capable of emitting photons to form a trapping region 30. Photons emitted from the first emitter form an optical path or beam 32 so as to optically couple the first emitter 35 to the trapping region 30. FIG. 4 also shows a second emitter 33 of the system 8. The second emitter 33 is capable of emitting photons into the trapping region 30. For example, photons emitted from the second emitter 33 form an optical path or beam 34 so as to optically couple the second emitter 33 to the trapping region 30. As shown, a modulator 31 is optically associated with photons emitted from the second emitter 33. For example, the modulator is optically associated with photons along optical path or beam 34. In another embodiment of the invention, the modulator can be coupled such as, for example, by electronic means to the second emitter.

FIG. 4 also shows a system 8 comprising a second modulator 41. The second modulator 41 is optically associated with photons emitted from the first emitter 35. For example, the modulator is optically associated with photons along optical path or beam 32. In another embodiment of the invention, the modulator 41 can be coupled such as, for example, by electronic means to the first emitter 35. Preferably, the second modulator 41 is capable of synchronously (out of phase) operating with the modulator 31 to periodically couple photons emitted by at least one of the first emitter 35 or the second emitter 33 to the trapping region 30. For example, the second modulator 41 and modulator of the system 8 in FIG. 4 can operate synchronously to couple then decouple emitted photons from the trapping region 30. In one embodiment, the modulators can operate such that one of them can recouple the photons emitted by one of the emitters to the trapping region 30.

This coupling and decoupling can be considered to be a periodic coupling of photons via optical paths to the trapping region. The second modulator 41 and the first modulator 31 operate synchronously (out of phase) such that they couple and decouple emitted photons from the emitters one at a time. Such operation of a system of the invention can limit or prevent destructive photophysics originating from both the first emitter and the second emitter being “on” or emitting photons into the trapping region at the same time.

In one aspect, the modulator 41 is operable to periodically couple photons emitted by the first emitter 35 to the trapping region 30. For example, the modulator 41 can operate by mechanical or electrical means to interrupt the optical path or beam 32 from the first emitter 35 such that the emitter is decoupled from the trapping region 30. The modulator 41 can then recouple the photons emitted by the first emitter 35 to the trapping region 30. In one aspect of the invention, this coupling and decoupling can be considered to be a periodic coupling of photons via an optical path to the trapping region.

The modulator 41 of FIG. 4 can, for example, be a device or member that can mechanically or otherwise physically be in contact with and, for example, decouple emitted photons of the first emitter 35 from the trapping region 30. Similarly, for example, the modulator 41 can interrupt or chop photons before they enter the trapping region. Decoupling, chopping, interrupting or modulating emitted photons, as well as other suitable approaches such as the exemplary approaches described herein, can also occur periodically. As described herein, for example, the modulator 41 can be electronically coupled to at least one of the first or second emitter.

A second modulator coupled to the first emitter can, for example, be used to periodically couple photons emitted by the first emitter to the trapping region. The second modulator can, for example, be electronically coupled to the first emitter to duty-cycle, or power on and off, the first emitter. In one embodiment, a second modulator of a system of the invention is operable to enable photon beam shuttering from the first emitter. The invention contemplates any suitable means by which to facilitate or otherwise carry out photon beam shuttering using a second modulator. For example, the second modulator can be based on principles or means of pulse picking using acousto-optic deflectors (AODs), Bragg cells, electro-optic devices such as Pockels cells, physical chopping, direct triggering or combinations thereof. Such exemplary means of photon shuttering to decouple and then recouple an optical beam or path can also be performed in conjugation with, or independently by, duty cycling.

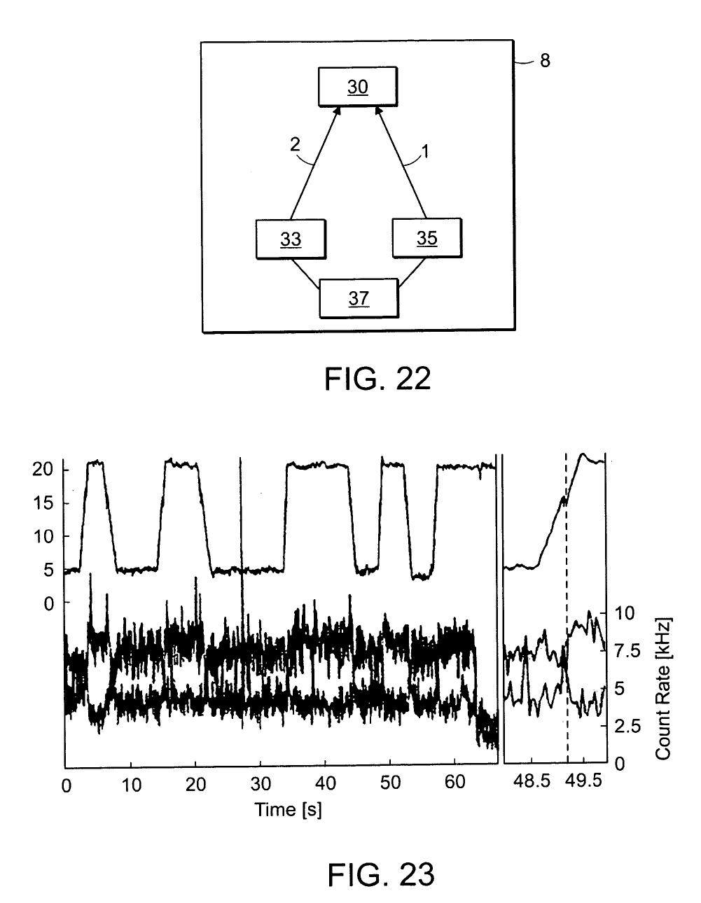

In one embodiment, the present invention provides the system shown in FIG. 22. As shown, the system 8 comprises a first emitter 35. The first emitter is capable of emitting photons to form a trapping region 30. Photons emitted from the first emitter form an optical path or beam 1 so as to optically couple the first emitter 35 to the trapping region 30. FIG. 22 also shows a second emitter 33 of the system 8. The second emitter 33 is capable of emitting photons into the trapping region 30. For example, photons emitted from the second emitter 33 form an optical path or beam 2 so as to optically couple the second emitter 33 to the trapping region 30. As shown, a modulator 37 is coupled to the first emitter 35 and the second emitter 33. In one aspect, the modulator can be coupled such as, for example, by electronic means to at least one of the first emitter or the second emitter.

In one embodiment, the system 8 of FIG. 22 comprises a first emitter 35 that is capable of being pulsed. Such pulsing of the first emitter 35 can be carried out by any suitable means such as, for example, means appreciated by those of ordinary skill in the art. Moreover, the second emitter 33 can also be capable of being pulsed. Such pulsing of the second emitter 33 can be carried out by any suitable means such as, for example, means appreciated by those of ordinary skill in the art. Preferably, in the system 8 of the invention, the first emitter 35 and second emitter 33 can each be pulsed synchronously so as to periodically couple photons emitted by at least one of the first emitter or the second emitter to the trapping region 30. Such pulsing can be facilitated, modulated or otherwise carried out by the modulator 37 of the system 8.

In one aspect, the modulator 37 is operable to periodically couple photons emitted by at least one of the first emitter 35 or the second emitter 33 to the trapping region 30. The modulator 37 can operate by mechanical or electrical means to interrupt the optical path or beam 2 from the second emitter 33 such that the emitter is decoupled from the trapping region 30, as well as to interrupt the optical path or beam 1 from the first emitter 35 such that the emitter is decoupled from the trapping region 30. The modulator 37 can then facilitate, modulate or otherwise carry out recoupling the photons emitted by the first emitter 35 and the second emitter 33 to the trapping region 30. This coupling and decoupling can be considered to be a periodic coupling of photons via an optical path to the trapping region. Such coupling and decoupling can also limit or prevent destructive photophysics originating from both the first emitter and the second emitter being “on” or emitting photons into the trapping region substantially at the same time.

The modulator 37 can also be a device, member or means that can mechanically, electrically or otherwise physically, for example, pulse the emitters. In one aspect, for example, the modulator 37 can interrupt or chop photons before they enter the trapping region. Decoupling, chopping, interrupting or modulating emitted photons, as well as other suitable approaches such as the exemplary approaches described herein, can also occur periodically.

The modulator 37 can, for example, be electrically coupled to an emitter to duty-cycle, or power on and off, at least one of the first emitter 35 or second emitter 33, or both. Preferably, a modulator of a system of the invention is operable to enable photon beam shuttering from at least one of the first or second emitter. The invention contemplates any suitable means by which to facilitate or otherwise carry out photon beam shuttering. For example, the modulator in FIG. 22 can be based on principles or means of pulse-picking using acousto-optic deflectors (AODs), Bragg cells, electro-optic devices such as Pockels cells, physical chopping, direct triggering or combinations thereof. Such exemplary means of photon shuttering to decouple and then recouple an optical beam or path can also be performed in conjugation with, or independently by, duty cycling.

FIG. 5 is a representation of a method according to a preferred embodiment of the invention. As shown, the method includes a Step 50 comprising providing a system comprising a first emitter capable of emitting photons to form a trapping region, wherein photons emitted from the first emitter optically couple the first emitter to the trapping region; a second emitter capable of emitting photons into the trapping region, wherein photons emitted from the second emitter optically couple the second emitter to the trapping region; and a modulator coupled to one of or both the emitters and, for example, capable of optically associating with photons emitted from at least one of the first or second emitters, wherein the modulator is operable to periodically couple photons emitted by at least one of the first or second emitters to the trapping region. The method can also comprise a Step 51 comprising emitting photons periodically from the first emitter and the second emitter in alternating fashion into the trapping region. The method can also comprise a Step 52 comprising synchronously alternating excitation of and imparting photon force to a target, such as a synthetic or natural compound, molecule, biological molecule, particle cell, object or any of the targets described herein and combinations thereof. The method can also comprise a Step 53 comprising carrying out force-fluorescence microscopy of the target, including, for example, imparting a detection signal from a detection source to engage the target and detecting the detection signal.

In one aspect, the second emitter of a system of the invention can be used to carry out single molecule fluorescence. Exemplary single molecule fluorescence is further described below. Single-molecule fluorescence such as pulsed excitation can be used in single-molecule spectroscopic evaluations. Pulsed excitation provides the advantages of using gated detectors to reject background light during times when there is no fluorescence signal. In such evaluations, protein labeling can be achieved by direct covalent linkages to functionalized fluorophores or by using labeled antibodies. The fluorescence signal from an individual or small numbers of fluorophores can provide detailed information on interaction such as coverage level, degree of homogeneity and whether there is more than one type of interaction occurring.

Total internal reflection microscopy (TIR) can reduce background noise in single-molecule fluorescence. Exemplary TIR types that can be used with the invention include, without limitation, prism side and objective side. In another aspect of the invention, the first emitter can provide for an optical trapping region. An optical trapping region can exert forces ranging from, for example, sub pN to ˜500 pN, which is well suited for measuring single-molecule protein interactions to cell mechanical studies. Moreover, the nanometer-level position sensing resolution of a first emitter of a system of the invention can correspond with the length-scale of protein conformational change. Optical trapping regions can be formed by focusing an intense laser beam from, for example, the first emitter to a diffraction limited spot where radiation pressure constrains small particles, molecules and so forth. Photon forces applied to tethered objects (beads) by the first emitter can range in size from, for example, ˜40 nm to ˜5 μm, which is well suited for drug or other ligand molecule interactions. Force can be applied typically between a bead and the surface through a tether. As a mechanical probe, optical trapping regions are advantageous for cell or other biological evaluations given the non-invasive nature of light. In addition, varying, changing or manipulating photon forces can automate imparting photon forces. For example, photon forces can be used to trap, move, position, control or otherwise manipulate a target. Automated optical trapping can also be used for a first emitter of a system of the invention. Examples of such automation includes computer control over the trap position (using acousto-optic deflectors, for example) and over the sample position (using piezo stages, for example), as well as automated application of force in two dimensions and so forth, along with combinations thereof.

Automation in the first or second emitter of a system of the invention can also comprise, for example, components such as a piezo stage, acousto-optic deflector positioning of the trap beam, shutters, flipper mirrors cameras, detectors and acquisition routines to allow rapid calibration and measurement. For a system or method of the invention, out-of-phase synchronization can limit, minimize or avoid destructive photophysics originating from both the first emitter and the second emitter being “on” at the same time.

In one aspect, a system or method of the invention can be used or carried out, respectively, to, for example, evaluate the effects of force on the binding affinity between a single actin filament and actin binding proteins. Moreover, for example, single molecule mechanical examination of actin binding proteins in cross-linked actin superstructures and protein complexes can be carried out using a system of the invention, which can significantly advance the understanding of these pathways and permit expanding such evaluations to directional loading experiments. Furthermore, for example, a system and method of the invention can be used or carried out, respectively, to evaluate systems comprising a tethered bead configuration such, for example, as single protein binding to DNA complexes.

A system or method of the invention can be used or carried out, respectively, in, for example, applications involving cellular observations, in which mechanical force follow the transmission of force through cytoskeletal structures to an extracellular matrix. Furthermore, the invention can be used to evaluate cellular response upon the application of localized photon forces to a cell membrane through micro-beads and micropipettes.

An applied external field from a first emitter of the system of the invention is well suited for cell mechanical system evaluations. Such evaluations can yield, for example, new insight into the relationship of force and protein activity, leading to both greater understanding of basic cellular functions and advances in the prevention and treatment of a wide spectrum of diseases such as, for example, atherosclerosis, arthritis, cancer and others.

The invention can be used to explore the effects of applied force on proteins that are known to play a role in cellular mechanical processes. The invention can simultaneously combine optical trapping and single molecule fluorescence detection, permitting the access to critical information on biological systems. The invention can provide significant insight into biological systems, yielding both specific information and general observations such as, for example, observations of molecular biomechanical and cell mechanical processes.

In one aspect, the invention can comprise modulating between optical trapping and single molecule FRET. The invention can be used to evaluate a range of common single molecule fluorophores. Such fluorophores can include, for example, Cy3, other Cy dyes, several Alexa dyes such as, without limitation, Alexa555 and Alexa488, rhodamine, TMR, GFP and quantum dots. For example, FIG. 16 shows tables of relative fluorophore lifetimes for TMR, Alexa488 and Cy3 demonstrating the improvement factor observed when using a system of the invention operating with modulation out of phase.

Given that fluorophore candidates are commercially available in biotin-labeled conjugates, they can be readily immobilized on streptavidin functionalized coverslips using common stock procedures and evaluated using the system of the invention or carrying out the method of the invention. For example, fluorophore lifetime measurements at both the bulk and single molecule levels can be performed by using or carrying out a system or method, respectively, of the invention. Additional evaluations of fluorophore lifetimes can also use a DNA-based assay. Such an assay, which can be any suitable assay such as that employing short fluorescence labeled oligonucleotide tethers in a combined force-fluorescence unzipping measurement, can provide a rapid evaluation of individual dyes in either a single molecule or fluorescence energy transfer configuration using a system, or carrying out a method, of the invention. Such evaluations can also be extended to more advanced systems, such as, without limitation, fluorescence resonant energy transfer.

For example, with fluorescence labels chosen based on fluorophore lifetime evaluations by a system or method of the invention, such labeling assays can be employed to link dye markers to actin such as including, without limitation, actin binding proteins or α-actinin. Moreover, for example, both G-actin polymerization assays with Alexa488 and α-actinin antibody labeling, which can be carried out with rhodamine, can also be adapted to incorporate a dye and evaluated with direct laser excitation by a system or method of the invention.

Labeling of molecular components can also permit additional optimization of single molecule fluorescence assays using a system or method of the invention. The invention can also be used in automated and chemical anti-fade reagent applications. Such automation applications of the invention can provide for rapid location and measurement of active single molecules to minimize their laser exposure, while chemical techniques can reduce fluorescence quenching effects of buffer components. Automation can be carried out by any suitable means such as, for example, computer control comprising control of a series of shutters, flipper mirrors, motorized stages, acousto-optic devices, analog-to-digital signal conversion (as well as combinations thereof) and incorporated in the invention to permit rapid data acquisition and position correlation between the intensified CCD camera and SAPD detectors. The invention can also be used in applications that enhance chemical fluorophores such as, for example, buffer degassing, introduction of β-mercaptoethanol and the use of glucose oxidase catalase systems for oxygen removal. Such enhancements can enhance sensitivity to single molecule fluorescence as carried out by a system or method of the invention, which can provide extra latitude in molecular system design and fluorescence signal sensitivity.

The invention can also be used with single molecule fluorescence systems and actin-tethered beads. Such single molecule fluorescence systems and actin-tethered beads can employ microfluidic substrates, cells and so forth, as described above, for rapid sampling and reagent introduction. Tethered beads can be positioned in an optical trapping region and subjected to photon forces alternated with fluorescence excitation using a system of the invention. These beads can also be moved laterally with the optical trap of the invention so as to exert a force on the actin filament tether and deform the protein binding site. Application of a variety of static forces can also give different degrees of deformation, ranging from negligible applied force by a first emitter to approximately 100 pN.

Using a system or carrying out a method of the invention, the location of tensed filament components can also be evaluated and these components can subsequently be allowed to photobleach and then to interact with dye-labeled □-actinin at single molecule concentrations, typically at the nM level. In another approach, two spectrally separated dyes can be use to shift excitation wavelength from the filament dye to that of α-actinin, in order to limit or prevent interference from filament emission. As actin binding protein approaches darkened filament, its fluorescent signal becomes visible, at the single molecule level this appears as a step-like appearance of signal that can then be correlated to the known position of the actin filament. Binding-time distributions, which can be evaluated by compiling individual time-dependent appearance and disappearance of α-actinin emission signals, can then be related to the applied photon force from the first emitter so as to demonstrate the effect of force on actin and actin binding proteins.

A system of the invention can also be used for evaluations at certain concentrations using microfluidic control over rapidly exchanging buffers, which can also provide additional elucidation of the nature of α-actinin binding. Such evaluations can be arranged by polymerizing F-actin in the presence of higher concentrations of α-actinin. Application of photon force to the filament via the first emitter can then cause deformation of the protein binding site so as to facilitate observation of force dependent binding changes to actin filaments, which can be observed with time dependent changes in fluorescence signaling though the use of a second emitter of a system of the invention.

The invention is also contemplated for use in the evaluation of protein complexes in live cells. Moreover, for example, application of the invention can be provided in directional unbinding experiments of actin binding polymers in cross-linked actin networks. For example, fluorescence resonance energy transfer from the second emitter can be used to determine which components are present in a protein complex while evaluating the location of structural changes during mechanical transitions.

The invention can also be used in a wide variety of DNA-based protein binding experiments including single molecule investigations of protein interactions with mechanically constrained DNA complexes. For example, DNA can be unzipped or sheared via a first emitter of a system of the invention. Such evaluations can also involve biotin-avidin and digoxigenin-anti-digoxigen attachment as will be appreciated by one of ordinary skill within the art.

The invention can be used for actin and actin binding protein assays. For example, the invention can be used with fluorescent labeling and bead tethering of actin filaments. In addition, the invention can be used with rhodamine labeled α-actinin. By way of example, the invention can be used in applications involving globular actin labeled with a variety of functionalized fluorescent dyes. Such labeling can be carried out by conventional protocols used for in vivo actin staining. Resulting actin monomers can polymerize into F-actin upon the addition of appropriate buffers, producing labeled filaments of controllable length. These filaments can then be stabilized with addition of phalloidin, which retards the de-polymerization process and can also be used in alternative labeling strategies.

By way of example, the invention can also be used in applications involving actin tethered beads. Tethering can be carried out by immobilization of a free filament end to a coverslip surface and adhesion of a bead to the opposing filament end. For example, such tethering can be carried out with F-actin polymerized from biotinylated G-actin to facilitate bead attachment with streptavidin-functionalized polystyrene beads. This form of F-actin can adhere to glass coverslips that have been treated with low concentrations of myosin monomers. Moreover, the addition of bovine serum albumin (BSA) effectively reduces multiple filament-myosin interactions. Subsequent addition of low concentration streptavidin beads can form actin tethered beads. These approaches can be applied to a F-actin tether assay that can be evaluated using a system or carrying out a method of the invention.

In certain applications, the invention can take advantage of the spectral separation of the Alexa488 labeled filaments and rhodamine labeled α-actinin to spatially image the formation of a bound complex at bulk level concentrations. In addition, the invention can be used for evaluating cells and cellular structures, including visualization of protein complexes and cellular component formations.

As described herein, fast beam shuttering can be achieved by, for example, “pulse pickers” using acousto-optic deflectors (AODs), Bragg cells, electro-optic devices such as Pockels cells, physical chopping or by direct triggering as well as combinations thereof. Timing scenarios with similar complexity can be used for injection seeding of regenerative amplifiers, multiple laser oscillator synchronization and signal gating of photon-echos. In one embodiment, the first and second emitter are shuttered using acousto-optic deflectors. This can be carried out by controlling the RF input for these deflectors with “on” and “off” inputs. Circuitry can also be used that shutters photon beams from the emitters at rates, for example, of about 50 kHz with, preferably, controllable duty cycles. In one aspect, the first and second emitters of a system of the invention are pulsed sources that can enable alternating trapping region coupling of photons emitted therefrom.

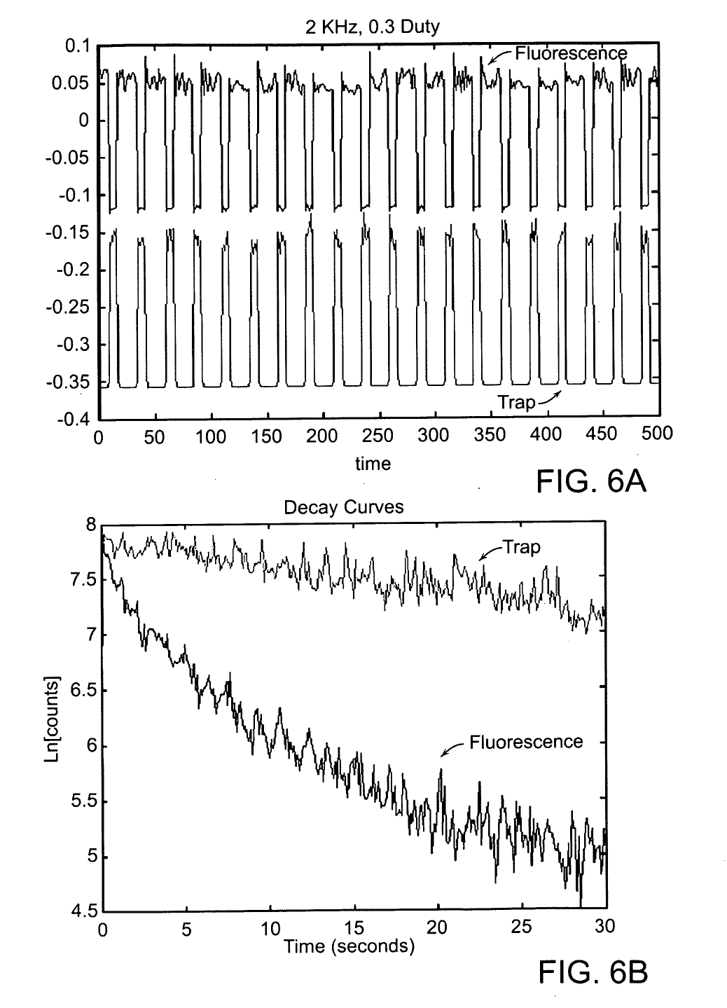

In one embodiment, fast switches or RF mixers, controlled with gate signals, toggle between “on” and “off” RF states to modulate the first and second emitters. The duty cycles can be controlled digitally with TTL pulses. FIG. 6 shows chopping or modulation, at 2 kHz, between first and second emitters with control over the duty cycle, set to 30% for the first emitter and 70% for the second. Evaluations on Cy3 labeled beads with chopping at 10 kHz and 50% duty cycle are also shown by the plot in FIG. 6. In the lower trace of this plot, beads are experiencing simultaneous trapping and excitation photon fluxes. The upper trace of the plot shows the same average fluxes but with the first emitter chopped relative to the fluorescence excitation beam.

The alternating between photons emitted from the first and second emitter of a system of the invention can occur at a much higher repetition rate (e.g., ˜50 kHz) than the typical roll-off frequencies of trapped beads (e.g., ˜1 kHz), such that trapping is generally not compromised. Time sharing the first emitter using acousto-optic deflectors to position the trapping region at various bead locations can also be used to trap multiple beads. Stiffness calibration measurements with the Stokes drag protocol also verify that the described trapping is generally not compromised. In addition to AODs being useful for rapidly shuttering the beam, they can control the incident power of both the first and second emitter at the specimen plane. A system or method of the invention can acquire signals using a multi-channel A to D board or a digital control to trigger acquisition of averaged signals and gate the acquisition of fluorescence photons.

Furthermore, the invention can provide improved fluorescence detection given that background noise can be gated away when there is no fluorescence signal. Such can also positively benefit signal-to-noise ratio. Moreover, for example, the gate width and repetition rate of such timing can be adjusted so that excited fluorophores have sufficient time to relax to the ground state.

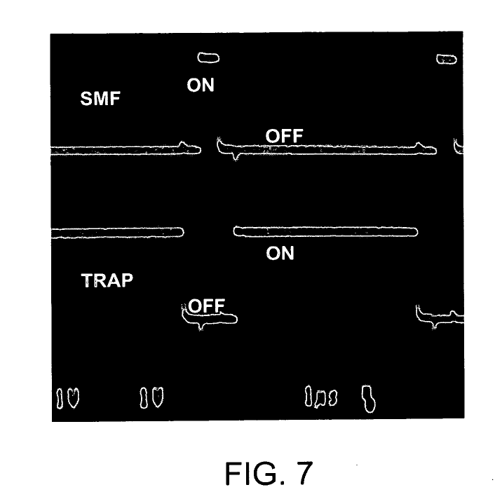

For the invention, as described above, fast switches or RF mixers, controlled with gate signals, can toggle between “on” and “off” RF states. In an alternative embodiment, there can be direct switching of the RF signal being generated using addressable RF generators. For example, the generators switches and mixers can be addressed using any suitable programming language, hardware, software or combinations thereof providing flexibility in implementing timing strategies. Such an implementation produces two out-of-phase signals that are independently timed with adjustable gate widths as demonstrated in FIG. 7.

In one embodiment, a system of the invention can comprise a microscope platform (e.g., Nikon TE 2000) and three lasers, for optical trapping, position sensing and fluorescence excitation. The fluorescence excitation laser can be a pulsed source in the range of, for example, about 390-550 nm from a doubled Ti:sapphire laser. Optical trapping and position sensing can use infrared wavelengths, whereas the visible window can be devoted to fluorescence excitation and emission. This wavelength separation can facilitate interfacing force and fluorescence without compromising either. The system also comprises two deflectors (AODs) for controlling the fluorescence excitation and position sensing beams and additional timing electronics. Flexibility in the single-molecule fluorescence detection enable configurations for capturing polarized, FRET donor and acceptor and time-resolved emissions. Filters can isolate the fluorescence signal while blocking the position sensing and trapping beams. High-efficiency, holographic, notch-plus filters (Kaiser optical) can also block the detection and fluorescence excitation beams. The AODs can assist with positioning the trap beam, while, for example, a piezo stage allows for precise positioning of the target.

Modifications such as to the microscope of a system of the invention can also be employed for mechanical stabilization purposes. Such modifications can include, for example, a support platform having a coarse and fine positioning stage and providing room for mirrors that, for example, direct the trap, detector and fluorescence excitation beams. A microscope of a system of the invention can also contain a position detector branch affixed to a condenser. This branch can hold filters that isolate the position detection signal from the trap and fluorescence excitation light.

A tunable Ti:sapphire laser system can be used as a fluorescence excitation source. The laser can be positioned on an adjacent optical table and fiber-coupled to a system of the invention through a short fiber. Wavelength tuning and second-harmonic generation to produce light in the 390-550 nm range can occur before coupling. Pulse compression may not be necessary after delivery given that all second-harmonic generation can be carried out prior to fiber coupling. For synchronizing, the laser can serve as a master clock and be cavity dumped or pulse picked using AODs. This tunable pulsed light source for a system or method of the invention can permit spectroscopically investigating the destructive photophysics of a range of fluorophores, while providing maximum flexibility in fluorescence excitation.

Alternative fluorescence excitation strategies include, for example, pulsed diode sources, Q-switched sources or chopping a CW beam. Time correlated single photon counting (TCSPC) can also be used to monitor fluorophore lifetimes and discriminate against background. Gated detection can permit removing background signals from scattering signals and permit identification, via lifetime, of two similar color fluorophores.

The first emitter can be used to, for example, trap about 10 beads. Moreover, high resolution position sensing for two traps can be accomplished by splitting the first emitter and detector beams using two quadrant photodiodes for detection. For example, a single quadrant photodiode can simultaneously be used to track multiple objects by time-sharing the position of the detection beam in parallel with the first emitter beam, for example, in both time and position. The detector beam can also be modulated in phase with the trap. Back focal plane detection can also be used for position sensing. In addition, for example, trapping multiple objects can allow for the construction of geometries such as filament-filament interactions at user-defined angles. Additionally, force probes can also be positioned on the surface of a cell to monitor cell motility and membrane mechanics with a system of the invention.

Shown in FIG. 23 is a fluorescence resonance energy transfer (FRET) measurement. A force is imparted to open a single hairpin of DNA while recording to FRET signal going from high FRET (closed) to low FRET (open). The mechanical trace is shown on top with a line at about 15-20 pN indicating where the hairpin opens. This is an example of actuation of a mechanical event during a fluorescence measurement using a chopper to alternate between two optical signals.

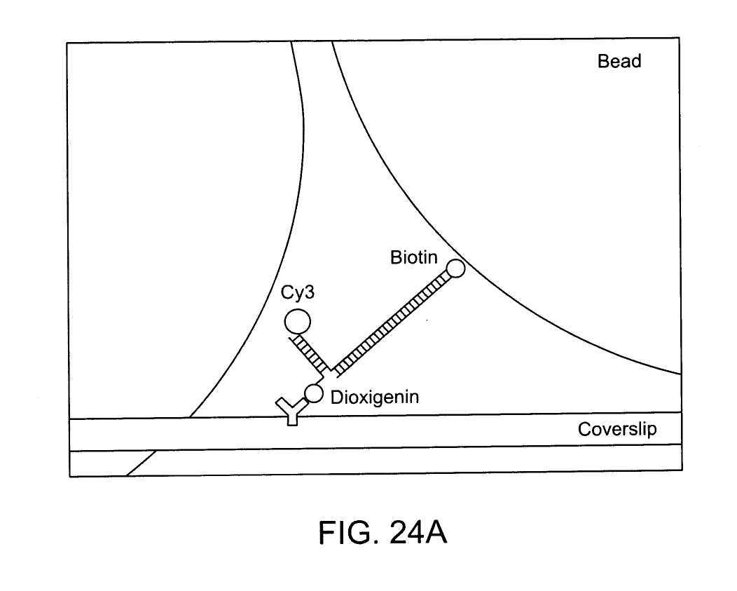

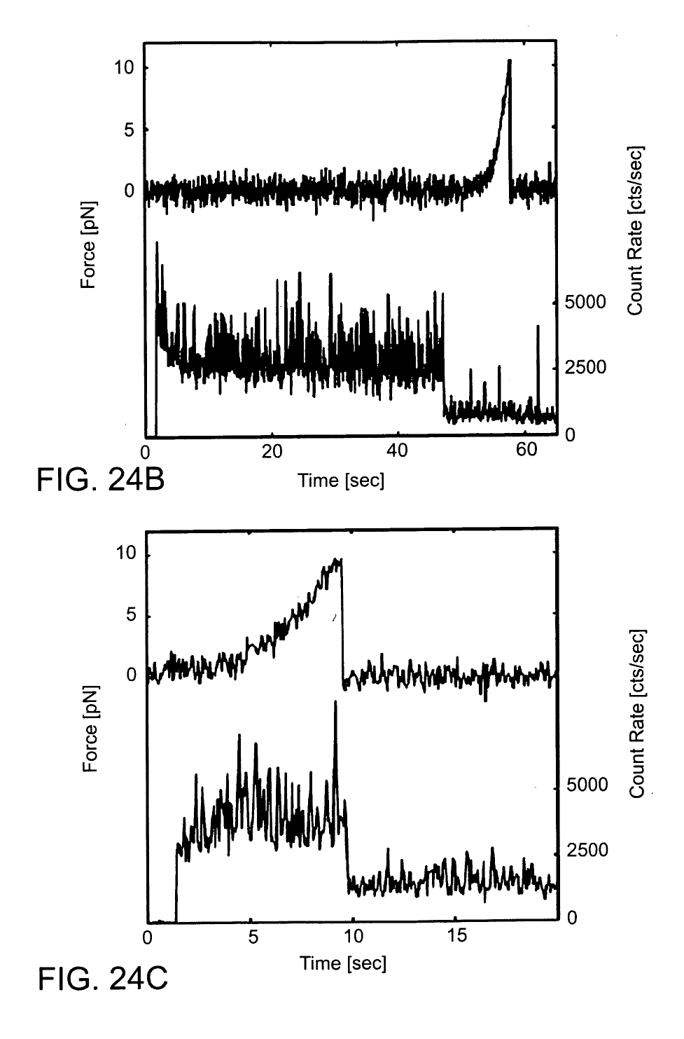

A preferred embodiment of the invention applies synchronization of the trapping and fluorescence excitation lasers to the unzipping of a 15-bp region in a simple dsDNA system shown in FIGS. 24A-24C. The modulation and power settings for both lasers were kept as described above. Cy3 emission was used to confirm mechanical events occurring in response to the application of external mechanical loads. In this case, upon dsDNA unzipping, the fluorescence emission was reduced to background levels simultaneously with the mechanical break, confirming that the dsDNA was unzipped (FIG. 24C). The force required to unzip the 15-bp dsDNA region, ˜10 pN, is consistent with control measurements (FIG. 24B). Cy3 has been used in a combined, coincident single molecule fluorescence and optical tweezers mechanical measurement. As a control, Cy3 was irradiated with the OP arrangement until irreversibly photobleaching, which occurred at ˜45 s (FIG. 24B (lower trace). No force was exerted on the dsDNA system during this period, but after photobleaching, the tether was loaded at 100 nm/s until rupture was observed at ˜10 pN (upper trace). The fluorophore emitted at a constant level and was not disturbed by the presence of the trap. However, when compared to the traces from the system in the single molecule fluorescence longevity measurements, there was a small increase in background and signal noise likely due to the presence of the bead and slightly different molecular configuration.

Thus FIGS. 24A-24C demonstrate a measurement using the interlaced modulation technique showing the unzipping geometry for a 15-bp dsDNA system. It is attached on one end to a trapped bead via a biotin-streptavidin interaction and immobilized on the other end by means of a digoxigenin-antibody linkage. The 15-bp region of interest is labeled with a Cy3 fluorophore to confirm the location and timing of the unzipping mechanical event. As seen in FIG. 24C, the simultaneous trace of the force exerted on the dsDNA system (upper trace) and the photon emission rate of the Cy3 fluorophore (lower trace). This event is correlated with a simultaneous drop to background in the Cy3 emission rate, corroborating the location of the break. The fluorescence excitation was shuttered for 1.5 s after position acquisition started.

While the present invention has been described herein in conjunction with a preferred embodiment, a person with ordinary skill in the art, after reading the foregoing specification, can effect changes, substitutions of equivalents and other types of alterations to that set forth herein. Each embodiment described herein can also have included or incorporated therewith such variations as disclosed in regard to any or all of the other embodiments. Thus, it is intended that that described herein be limited only by definitions contained in any claims pending herefrom and any equivalents thereof.

1. A system for force-luminescence measurement, the system comprising:
a first emitter capable of emitting photons to form a trapping region, photons emitted from the first emitter being optically couple to the trapping region;
a second emitter capable of emitting photons into the trapping region, photons emitted from the second emitter being optically coupled to the trapping region; and
a control system operable to periodically actuate delivery of photons by at least one of the first emitter or the second emitter to the trapping region.

2. The system of claim 1, wherein the control system comprises a modulator that mechanically or electrically periodically couples photons emitted by at least one of the first emitter or the second emitter to the trapping region.

3. The system of claim 2, wherein the modulator controllably periodically couples photons emitted by at least one of the first emitter or the second emitter to the trapping region.

4. The system of claim 2, wherein the modulator is capable of optically associating with photons emitted from at least one of the first emitter or the second emitter to mechanically periodically couple photons emitted by at least one of the first emitter or the second emitter to the trapping region, or wherein the modulator is coupled to at least one of the first emitter or the second emitter to electrically periodically couple photons emitted by at least one of the first emitter or the second emitter to the trapping region.

5. The system of claim 2, wherein the modulator performs duty cycling to periodically couple photons emitted by at least one of the first emitter or the second emitter to the trapping region.

6. The system of claim 2, wherein the modulator periodically couples photons emitted by at least one of the first emitter or the second emitter to the trapping region by shuttering.

7. The system of claim 6, wherein shuttering is enabled by acousto-optical deflectors.

8. The system of claim 6, wherein shuttering is enabled by Bragg cells.

9. The system of claim 6, wherein shuttering is enabled by electro-optics.

10. The system of claim 9, wherein the electro-optics are Pockels cells.

11. The system of claim 6, wherein shuttering is enabled by chopping photon emissions.

12. The system of claim 6, wherein shuttering is enabled by triggering photon emissions.

13. The system of claim 6, wherein shuttering is carried out by duty cycling.

14. The system of claim 6, wherein shuttering is carried out at rates up to about 100 megahertz.

15. The system of claim 6, wherein shuttering is carried out at rates up to about 100 megahertz with duty cycling.

16. The system of claim 1, wherein the first emitter is a laser.

17. The system of claim 1, wherein the second emitter is a laser.

18. The system of claim 17, wherein the laser is an excitation laser.

19. The system of claim 1, wherein the second emitter illuminates a material for microscopy.

20. The system of claim 1, wherein the second emitter comprises an excitation light source.

21. The system of claim 20, wherein excitation light source induces fluorescence.

22. The system of claim 1, wherein the second emitter induces fluorescence for microscopy.

23. The system of claim 1, wherein the first emitter traps a target in the trapping region.

24. The system of claim 1, wherein the first emitter positions a target in the trapping region.

25. The system of claim 1, wherein the first emitter controls a target in the trapping region.

26. The system of claim 1, wherein the first emitter manipulates a target in the trapping region.

27. The system of claim 1, wherein the first emitter moves a target in the trapping region.

28. The system of claim 1, wherein the first emitter imparts a force to a target in the trapping region.

29. The system of claim 23, wherein the target is a compound.

30. The system of claim 29, wherein the target is a synthetic or natural compound.

31. The system of claim 23, wherein the target is a molecule.

32. The system of claim 31, wherein the molecule is a biological molecule.

33. The system of claim 32, wherein the biological molecule comprises nucleic acid.

34. The system of claim 32, wherein the biological molecule comprises an amino acid.

35. The system of claim 32, wherein the biological molecule comprises a deoxyribonucleic acid.

36. The system of claim 34, wherein the biological molecule comprises a ribonucleic acid.

37. The system of claim 23, wherein the target is a particle.

38. The system of claim 37, wherein the particle is a nanoparticle.

39. The system of claim 23, wherein the second emitter excites the target.

40. The system of claim 1, wherein the second emitter induces fluorescence of the target.

41. The system of claim 1, wherein the second emitter illuminates the target to form an image.

42. The system of claim 2, wherein the modulator controls photons emitted by the second emitter.

43. The system of claim 2, wherein the modulator is coupled to the second emitter to enable shuttering of photons emitted from the second emitter.

44. The system of claim 2, wherein the system further comprises a second modulator, the second modulator is capable of optically associating with photons emitted from at least one of the first emitter or the second emitter, or coupled to at least one of the first emitter or the second emitter, wherein the second modulator is capable of synchronously operating with the modulator to periodically couple photons emitted by at least one of the first emitter or the second emitter to the trapping region.

45. The system of claim 44, wherein the second modulator is mechanically or electrically operable.

46. The system of claim 44, wherein the second modulator is controllably operable.

47. The system of claim 44, wherein the second modulator is capable of optically associating with photons emitted from the second emitter, or wherein the modulator is coupled to the second emitter.

48. The system of any of claim 44, wherein the second modulator is operable to carry out shuttering.

49. The system of claim 48, wherein shuttering is enabled by acousto-optical deflectors.

50. The system of claim 48, wherein shuttering is enabled by Bragg cells.

51. The system of claim 48, wherein shuttering is enabled by electro-optics.

52. The system of claim 51, wherein the electro-optics are Pockels cells.

53. The system of claim 48, wherein shuttering is enabled by chopping photon emissions.

54. The system of claim 48, wherein shuttering is enabled by triggering photon emissions.

55. The system of claim 44, wherein the second modulator controls duty cycling.

56. The system of claim 48, wherein shuttering is carried out at rates up to about 100 megahertz.

57. The system of claim 48, wherein shuttering is carried out at rates up to about 100 megahertz with duty cycling.

58. The system of claim 1 further comprising a processor that receives data frame detection system.

59. The system of claim 1 further comprising a first detector that detects position of a trapped object and a second detector that detects a spectral.

60. The system of claim 1 further comprising a photon counting detector that detects a spectral response of an object.

61. The system of claim 1 further comprising an imaging detector that detects an image of the object.

62. The system of claim 1 further comprising a broadband light source or lamp that illuminates an object.

63. A method for force-luminescence microscopy, the method comprising:
emitting photons periodically from a light source system into the trapping region;
providing excitation of a region of interest in the trapping region;
imparting photon forces to an object; and
applying excitation light and imparting a light induced force to the object.

64. The method of claim 63, the method further comprising providing a light source system emitting light at a first wavelength to apply the excitation light to the object and emitting light at a second wavelength to apply the force to the object.

65. The method of claim 64, the method further comprising synchronously alternatively between the first wavelength and the second wavelength.

66. The system of claim 63, wherein the target is a compound.

67. The method of claim 63, wherein the object is a synthetic or natural compound.

68. The method of claim 63, wherein the object is a molecule.

69. The method of claim 68, wherein the molecule is a biological molecule.

70. The method of claim 69, wherein the biological molecule comprises nucleic acid.

71. The method of claim 69, wherein the biological molecule comprises amino acid.

72. The method of claim 69, wherein the biological molecule comprises deoxyribonucleic acid.

73. The method of claim 69, wherein the biological molecule comprises ribonucleic acid.

74. The method of claim 63, wherein the object is a particle.

75. A system for delivering light to an object, the system comprising:
A light source that delivers light to a region of interest; and
An optical system that controls delivery of light from the light source to the region of interest such that light imparts a force to an object in the region of interest and that detects a light returning from the object.

76. The system of claim 75 wherein the light source emits light at a first wavelength and a second wavelength.

77. The system of claim 76 wherein the first wavelength imparts an optical force to the object and the second wavelength induces a spectral response by the object that is detected by a detector.

78. The system of claim 75 further comprising a controller that controls delivery of light to the region of interest from the light source.

79. The system of claim 78 wherein the controller synchronously switches between a plurality of light wavelengths to interleave the delivery of optical force with delivery of light for spectral detection.

80. The system of claim 75 wherein the light source comprises a first light emitter for optical trapping, a second light emitter for position detection and third light emitter for fluorescence detection.
